(19) United States
(12) Patent Application Publication
(10) Pub. No.: US 2020/0267800 A1
(43) Pub. Date: Aug. 20, 2020

(54) METHOD FOR PERFORMING S1 CONNECTION RELEASE BY MOBILITY MANAGEMENT OBJECT, MOBILITY MANAGEMENT OBJECT, METHOD FOR PERFORMING S1 CONNECTION RELEASE BY BASE STATION, AND BASE STATION

(71) Applicant: LG ELECTRONICS INC., Seoul (KR)

(72) Inventors: Taehun KIM, Seoul (KR); Jinsook RYU, Seoul (KR); Jaehyun KIM, Seoul (KR); Daewook BYUN, Seoul (KR); Sangmin PARK, Seoul (KR)

(21) Appl. No.: 15/781,659

(22) PCT Filed: Dec. 7, 2016
(86) PCT No.: PCT/KR2016/014276

§ 371 Date: Jun. 5, 2018

Related U.S. Application Data
(60) Provisional application No. 62/263,753, filed on Dec. 7, 2015.

(51) Int. Cl. H04W 76/38

(52) U.S. Cl. CPC H04W 76/38; H04W 88/16

(57) ABSTRACT

Data can be transmitted to a control plane rather than to a user plane. When a DL response to UL data transmitted in a non-access stratum (NAS) message is expected, user equipment (UE), an eNB and a mobility management entity (MME) do not immediately perform an S1 release procedure because a cause of the S1 release occurs, but proceed with a part of the S1 release procedure after a predetermined time.

### TECHNICAL FIELD

The present invention relates to a wireless communication system, and more particularly, to a method and apparatus for performing S1 connection release.

### BACKGROUND ART

Recently, various devices that require machine-to-machine (M2M) communication and a high data transfer rate, such as smartphones or tablet personal computers (PCs), have appeared and come into widespread use. This has rapidly increased the quantity of data which needs to be processed in a cellular network. In order to satisfy such rapidly increasing data throughput, various technologies such as a carrier aggregation (CA) technology for efficiently using more frequency bands, a cognitive ratio technology, a multi-antenna technology for increasing data capacity in a restricted frequency, a multi-base station (BS) cooperative technology, and the like have been developed.

In addition, communication environments have evolved such that the density of accessible nodes is increased in the vicinity of a user equipment (UE). Here, the node means a fixed point capable of transmitting/receiving radio signals to/from UEs using one or more antennas. The communication system where the node density is high may provide high quality communication services to UEs through cooperation between nodes.

### DISCLOSURE OF THE INVENTION

### Technical Task

Due to the introduction of new radio communication technologies, the number of UEs to which a BS should provide a service in a prescribed resource region increases and the amount of uplink data and uplink control information that the BS should receive from the UEs increases. Since the amount of resources available to the BS for communication with the UE(s) is finite, a new method in which the BS efficiently transmits/receives data and/or control information to the UE(s) using the finite radio resources is needed.

In addition, due to the recent development of smart devices, a new method for efficiently transmitting/receiving a small amount of data or rarely occurring data is also required.

It will be appreciated by persons skilled in the art that the objects that could be achieved with the present invention are not limited to what has been particularly described hereinabove and the above and other objects that the present invention could achieve will be more clearly understood from the following detailed description.

### Technical Solutions

Data can be transmitted through a control plane rather than a user plane. When a downlink (DL) response to uplink (UL) data, which was transmitted in a non-access stratum (NAS) message, is expected, a user equipment (UE), an evolved node B (eNB), and a mobility management entity (MME) do not perform the entirety of an S1 release procedure based on causes of the S1 release but performs a process for informing the UE that the connection is released only. After elapse of a predetermined time, the UE, eNB and MME proceed to perform the rest of the S1 release procedure.

In an aspect of the present invention, provided herein is a method for performing an S1 release procedure by a mobile management entity (MME) in a wireless communication system. The method may include: receiving, from a user equipment (UE), a non-access stratum (NAS) UL message including uplink (UL) data and release assistance information indicating that the UE expects a downlink (DL) response to the UL data; forwarding the UL data to a serving gateway (S-GW); when the DL response to the UL data is received from the S-GW, starting a first timer and transmitting, to an evolved node B (eNB), an S1 UE Context Release Command message including the DL response; and performing the S1 release procedure after expiration of the first timer.

In another aspect of the present invention, provided herein is a method for performing an S1 release procedure by a base station (evolved node B (eNB)) in a wireless communication system. The method may include: receiving a S1 UE Context Release Command message from a mobile management entity (MME); transmitting a radio resource control (RRC) Connection Release message to a user equipment (UE); and performing the S1 release procedure including RRC connection release. When a message including an indication indicating that the UE expects a downlink (DL) response to uplink (UL) data, which was transmitted by the UE in a non-access stratum (NAS) UL message, is received, the S1 release procedure may be performed after expiration of a first timer, which started with the transmission of the RRC Connection Release message.

In a further aspect of the present invention, provided herein is a mobile management entity for performing an S1 release procedure in a wireless communication system. The MME may include: a radio frequency (RF) unit; and a processor configured to control the RF unit. In this case, the processor may be configured to: control the RF unit to receive, from a user equipment (UE), a non-access stratum (NAS) UL message including uplink (UL) data and release assistance information indicating that the UE expects a downlink (DL) response to the UL data; control the RF unit to forward the UL data to a serving gateway (S-GW); when the DL response to the UL data is received from the S-GW, start a first timer and control the RF unit to transmit, to an evolved node B (eNB), an S1 UE Context Release Command message including the DL response; and perform the S1 release procedure after expiration of the first timer.

In a still further aspect of the present invention, provided herein is a base station (evolved Node B (eNB)) for performing an S1 release procedure in a wireless communication system. The eNB may include: a radio frequency (RF) unit; and a processor configured to control the RF unit. In this case, the processor may be configured to: control the RF unit to receive a S1 UE Context Release Command message from a mobile management entity (MME); control the RF unit to transmit a radio resource control (RRC) Connection Release message to a user equipment (UE); and perform the S1 release procedure including RRC connection release. When a message including an indication indicating that the UE expects a downlink (DL) response to uplink (UL) data, which was transmitted by the UE in a non-access stratum (NAS) UL message, is received, the processor may be configured to perform the S1 release procedure after expiration of the first timer, which started with the transmission of the RRC Connection Release message.

In each aspect of the present invention, a Release Access Bearers Request message may be transmitted to the S-GW after the expiration of the first timer.

In each aspect of the present invention, the S1 UE Context Release Command message or the RRC Connection Release message may include a first timer value of the first timer.

In each aspect of the present invention, the S1 UE Context Release Command message may include a cause value, and the cause value may indicate either that the DL response to the UL data is received or that the DL response to the UL data is not received.

In each aspect of the present invention, the UL data may be transmitted to a packet data network (PDN) gateway (P-GW) through the S-GW in a first general packet radio service (GPRS) tunneling protocol (GTP) message, and the DL response may be received from the P-GW through the S-GW in a second GTP message. The first GTP message may include an indication indicating that the DL response to the UL data is required or a sequence number of the UL data, and the second GTP message may include the sequence number.

In each aspect of the present invention, transmitting the UL data to the S-GW may include starting a second timer different from the first timer. When the DL response is received from the S-GW before expiration of the second timer, the MME may stop the second timer, start the first timer, and transmit the S1 UE Context Release Command message to the eNB.

In each aspect of the present invention, the RRC Connection Release message may include a cause value identical to the cause value in the S1 UE Context Release Command message.

### Advantageous Effects

According to the present invention, radio communication signals can be efficiently transmitted/received, and thus unnecessary signaling can be reduced in a wireless communication system.

According to the present invention, a low-complexity and lost-cost UE can communicate with the network while maintaining backward compatibility with the legacy system.

According to an embodiment of the present invention, it is possible to implement a low-complexity and lost-cost UE.

According to an embodiment of the present invention, a UE can communicate with the network in a narrowband.

According to an embodiment of the present invention, it is possible to transmit/receive a small amount of data in an efficient manner.

It will be appreciated by persons skilled in the art that the effects that can be achieved through the present invention are not limited to what has been particularly described hereinabove and other advantages of the present invention will be more clearly understood from the following detailed description.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a diagram illustrating a brief structure of an EPS (evolved packet system) that includes an EPC (evolved packet core).

FIG. 2 is an exemplary diagram illustrating an architecture of a general E-UTRAN and a general EPC.

FIG. 3 is an exemplary diagram illustrating a structure of a radio interface protocol on a control plane.

FIG. 4 is an exemplary diagram illustrating a structure of a radio interface protocol on a user plane.

FIG. 5 is a diagram illustrating LTE protocol stacks for user and control planes.

FIG. 6 is a flow chart illustrating a random access procedure.

FIG. 7 is a diagram illustrating a connection procedure in a radio resource control (RRC) layer.

FIG. 8 is a diagram illustrating a UE triggered service request procedure.

FIG. 9 is a diagram illustrating in brief a data transmission procedure in accordance with Control Plane CIoT EPS optimization regarding radio signals.

FIG. 10 is a diagram illustrating an overall procedure for transferring data in an EPS system when Control Plane CIoT EPS optimization is used.

FIG. 11 is a diagram illustrating an overall procedure for transferring mobile-terminated data in an EPS system according to Control Plane CIoT EPS optimization.

FIG. 12 is a diagram for explaining an S1 connection release procedure.

FIG. 13 is a diagram illustrating in brief an S1 connection release procedure according to the present invention when Control Plane CIoT optimization is used.

FIG. 14 is a diagram illustrating an exemplary S1 connection release procedure according to a proposal of the present invention.

FIG. 15 is a diagram illustrating another exemplary S1 connection release procedure according to the proposal of the present invention.

FIG. 16 is a diagram illustrating an exemplary S1 connection release procedure according to another proposal of the present invention.

FIG. 17 is a diagram illustrating an exemplary S1 connection release procedure according to a further proposal of the present invention.

FIG. 18 is a diagram illustrating the configuration of a node device according to a proposed embodiment.

### BEST MODE FOR INVENTION

Although the terms used in the present invention are selected from generally known and used terms, terms used herein may be varied depending on operator's intention or customs in the art, appearance of new technology, or the like. In addition, some of the terms mentioned in the description of the present invention have been selected by the applicant at his or her discretion, the detailed meanings of which are described in relevant parts of the description herein. Furthermore, it is required that the present invention is understood, not simply by the actual terms used but by the meanings of each term lying within.

The following embodiments are proposed by combining constituent components and characteristics of the present invention according to a predetermined format. The individual constituent components or characteristics should be considered optional factors on the condition that there is no additional remark. If required, the individual constituent components or characteristics may not be combined with other components or characteristics. In addition, some constituent components and/or characteristics may be combined to implement the embodiments of the present invention. The order of operations to be disclosed in the embodiments of the present invention may be changed. Some components or characteristics of any embodiment may also be included in other embodiments, or may be replaced with those of the other embodiments as necessary.

In describing the present invention, if it is determined that the detailed description of a related known function or construction renders the scope of the present invention unnecessarily ambiguous, the detailed description thereof will be omitted.

In the entire specification, when a certain portion “comprises or includes” a certain component, this indicates that the other components are not excluded and may be further included unless specially described otherwise. The terms “unit”, “-or/er” and “module” described in the specification indicate a unit for processing at least one function or operation, which may be implemented by hardware, software or a combination thereof. The words “a or an”, “one”, “the” and words related thereto may be used to include both a singular expression and a plural expression unless the context describing the present invention (particularly, the context of the following claims) clearly indicates otherwise.

The embodiments of the present invention can be supported by the standard documents disclosed in any one of wireless access systems, such as an IEEE 802.xx system, a 3rd Generation Partnership Project (3GPP) system, a 3GPP Long Term Evolution (LTE)/LTE-Advanced (LTE-A) system, and a 3GPP2 system. That is, the steps or portions, which are not described in order to make the technical spirit of the present invention clear, may be supported by the above documents.

In addition, all the terms disclosed in the present document may be described by the above standard documents. In particular, the embodiments of the present invention may be supported by at least one of P802.16e-2004, P802.16e-2005, P802.16.1, P802.16p and P802.16.1b documents, which are the standard documents of the IEEE 802.16 system.

Hereinafter, the preferred embodiments of the present invention will be described with reference to the accompanying drawings. It is to be understood that the detailed description which will be disclosed along with the accompanying drawings is intended to describe the exemplary embodiments of the present invention, and is not intended to describe a unique embodiment which the present invention can be carried out.

It should be noted that specific terms disclosed in the present invention are proposed for convenience of description and better understanding of the present invention, and the use of these specific terms may be changed to another format within the technical scope or spirit of the present invention.

Terms used in the specification are defined as follows.
UMTS (Universal Mobile Telecommunications System): a GSM (Global System for Mobile Communication) based third generation mobile communication technology developed by the 3GPP.
EPS (Evolved Packet System): a network system that includes an EPC (Evolved Packet Core) which is an IP (Internet Protocol) based packet switched core network and an access network such as LTE and UTRAN. This system is the network of an evolved version of the UMTS.
NodeB: a base station of GERAN/UTRAN. This base station is installed outdoor and its coverage has a scale of a macro cell.
eNodeB: a base station of LTE. This base station is installed outdoor and its coverage has a scale of a macro cell.
UE (User Equipment): the UE may be referred to as terminal, ME (Mobile Equipment), MS (Mobile Station), etc. Also, the UE may be a portable device such as a notebook computer, a cellular phone, a PDA (Personal Digital Assistant), a smart phone, and a multimedia device. Alternatively, the UE may be a non-portable device such as a PC (Personal Computer) and a vehicle mounted device. The term “UE”, as used in relation to MTC, can refer to an MTC device.
HNB (Home NodeB): a base station of UMTS network. This base station is installed indoor and its coverage has a scale of a micro cell.
HeNB (Home eNodeB): a base station of an EPS network. This base station is installed indoor and its coverage has a scale of a micro cell.
MME (Mobility Management Entity): a network node of an EPS network, which performs mobility management (MM) and session management (SM).
PDN-GW (Packet Data Network-Gateway)/PGW/P-GW: a network node of an EPS network, which performs UE IP address allocation, packet screening and filtering, charging data collection, etc.
SGW (Serving Gateway/S-GW: a network node of an EPS network, which performs mobility anchor, packet routing, idle-mode packet buffering, and triggering of an MME's UE paging.
PCRF (Policy and Charging Rule Function): a network node of an EPS network, which performs a policy decision to dynamically apply different QoS and charging policies for each service flow.
OMA DM (Open Mobile Alliance Device Management): a protocol designed to manage mobile devices such as a cell phone, a PDA, and a laptop computer, which performs functions such as device configuration, firmware upgrade, error report, and the like.
OAM (Operation Administration and Maintenance): a set of network management functions, which provides network error display, performance information, data, and management functions.
NAS (Non-Access Stratum): a higher stratum of a control plane between a UE and MME. As a functional layer for exchanging signaling and traffic messages between a UE and core network in LTE/UMTS protocol stack, the NAS supports UE mobility, a session management procedure for establishing and maintaining an IP connection between a UE and PDN GW, and IP address management.
EMM (EPS Mobility Management): as a sub layer of the NAS layer, the EMM may be in either “EMM-Registered” state or “EMM-Deregistered” state depending on whether a UE is attached or detached to the network.
ECM (EMM Connection Management) connection: a signaling connection for exchanging NAS messages, which is established between a UE and an MME. The ECM connection is a logical connection configured with an RRC connection between a UE and an eNB and an S1 signaling connection between the eNB and an MME. When the ECM connection is established/terminated, the RRC and S1 signaling connections are established/terminated. The establishment of the ECM connection means that the UE establishes the RRC connection with the eNB and the MME establishes the S1 signaling connection with the eNB. Depending on whether the NAS signaling connection, that is, ECM connection is established, an ECM may be in either “ECM-Connected” state or “ECM-Idle” state.
AS (Access-Stratum): the AS includes a protocol stack between a UE and a radio (or access) network, which manages transmission of data and network control signals.
NAS configuration MO (Management Object): the NAS configuration MO is a management object (MO) used to configure parameters related to NAS functionality for a UE.
PDN (Packet Data Network): a network in which a server supporting a specific service (e.g., a Multimedia Messaging Service (MMS) server, a Wireless Application Protocol (WAP) server, etc.) is located.
PDN connection: a logical connection between a UE and a PDN, represented as one IP address (one IPv4 address and/or one IPv6 prefix).
APN (Access Point Name): a character string for indicating or identifying PDN. To access a requested service or network, a connection to a specific P-GW is required. The APN means a name (character string) predefined in a network to search for the corresponding P-GW (for example, it may be defined as internet.mnc012.mcc345.gprs).
RAN (Radio Access Network): a unit including a Node B, an eNode B, and a Radio Network Controller (RNC) for controlling the Node B and the eNode B in a 3GPP network, which is present between UEs and provides a connection to a core network.
HLR (Home Location Register)/HSS (Home Subscriber Server): a database having subscriber information in a 3GPP network. The HSS can perform functions such as configuration storage, identity management, and user state storage.
PLMN (Public Land Mobile Network): a network configured for the purpose of providing mobile communication services to individuals. This network can be configured per operator.
ANDSF (Access Network Discovery and Selection Function): This is one of network entities for providing a policy for discovering and selecting an access that can be used by a UE on an operator basis.
EPC Path (or Infrastructure Data Path): A user plane communication path through an EPC.
E-RAB (E-UTRAN Radio Access Bearer): A concatenation of an S1 bearer and a corresponding data radio bearer. When there is an E-RAB, the E-RAB is in a one-to-one mapping relationship with an EPS bearer for the NAS.
GTP (GPRS Tunneling Protocol): A group of IP-based communication protocols, which is used for carrying general packet radio services (GPRSs) in GSM, UMTS, and LTE networks. In the 3GPP architecture, GTP and proxy mobile IPv6 based interfaces are specified on various interface points. The GTP may be decomposed to serval protocols (e.g., GTP-C, GTP-U, GPT′, etc.). The GTP-C is used by a GPRS core network for the purpose of signaling between gateway GPRS support nodes (GGSNs) and serving GPRS support nodes (SGSNs). In addition, the GTP-C allows the SGSN to activate a session for a user (e.g., activation of a PDN context), deactivate the same session, adjust the quality of service parameters, or update the session for a subscriber operating in another SGSN. The GPT-U is used for carrying user data in the GPRS core network and between a radio access network and a core network.

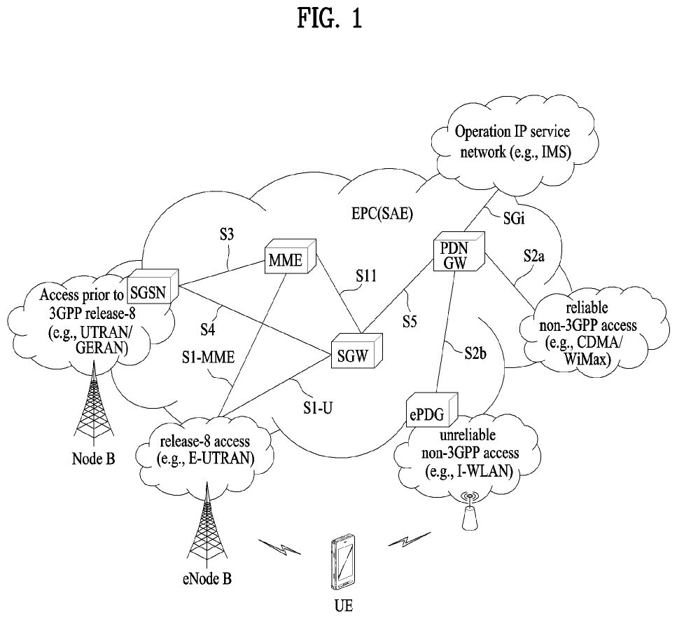

FIG. 1 is a schematic diagram showing the structure of an evolved packet system (EPS) including an evolved packet core (EPC).

The EPC is a core element of system architecture evolution (SAE) for improving performance of 3GPP technology. SAE corresponds to a research project for determining a network structure supporting mobility between various types of networks. For example, SAE aims to provide an optimized packet-based system for supporting various radio access technologies and providing an enhanced data transmission capability.

Specifically, the EPC is a core network of an IP mobile communication system for 3GPP LTE and can support real-time and non-real-time packet-based services. In conventional mobile communication systems (i.e. second-generation or third-generation mobile communication systems), functions of a core network are implemented through a circuit-switched (CS) sub-domain for voice and a packet-switched (PS) sub-domain for data. However, in a 3GPP LTE system which is evolved from the third generation communication system, CS and PS sub-domains are unified into one IP domain. That is, in 3GPP LTE, connection of terminals having IP capability can be established through an IP-based business station (e.g., an eNodeB (evolved Node B)), EPC, and an application domain (e.g., IMS). That is, the EPC is an essential structure for end-to-end IP services.

The EPC may include various components. FIG. 1 shows some of the components, namely, a serving gateway (SGW), a packet data network gateway (PDN GW), a mobility management entity (MME), a serving GPRS (general packet radio service) supporting node (SGSN) and an enhanced packet data gateway (ePDG).

The SGW operates as a boundary point between a radio access network (RAN) and a core network and maintains a data path between an eNodeB and the PDN GW. When. When a terminal moves over an area served by an eNodeB, the SGW functions as a local mobility anchor point. That is, packets. That is, packets may be routed through the SGW for mobility in an evolved UMTS terrestrial radio access network (E-UTRAN) defined after 3GPP release-8. In addition, the SGW may serve as an anchor point for mobility of another 3GPP network (a RAN defined before 3GPP release-8, e.g., UTRAN or GERAN (global system for mobile communication (GSM)/enhanced data rates for global evolution (EDGE) radio access network).

The PDN GW corresponds to a termination point of a data interface for a packet data network. The PDN GW may support policy enforcement features, packet filtering and charging support. In addition, the PDN GW may serve as an anchor point for mobility management with a 3GPP network and a non-3GPP network (e.g., an unreliable network such as an interworking wireless local area network (I-WLAN) and a reliable network such as a code division multiple access (CDMA) or WiMax network).

Although the SGW and the PDN GW are configured as separate gateways in the example of the network structure of FIG. 1, the two gateways may be implemented according to a single gateway configuration option.

The MME performs signaling and control functions for supporting access of a UE for network connection, network resource allocation, tracking, paging, roaming and handover. The MME controls control plane functions associated with subscriber and session management. The MME manages numerous eNodeBs and signaling for selection of a conventional gateway for handover to other 2G/3G networks. In addition, the MME performs security procedures, terminal-to-network session handling, idle terminal location management, etc.

The SGSN handles all packet data such as mobility management and authentication of a user for other 3GPP networks (e.g., a GPRS network).

The ePDG serves as a security node for a non-3GPP network (e.g., an I-WLAN, a Wi-Fi hotspot, etc.).

As described above with reference to FIG. 1, a terminal having IP capabilities may access an IP service network (e.g., an IMS) provided by an operator via various elements in the EPC not only based on 3GPP access but also on non-3GPP access.

Additionally, FIG. 1 shows various reference points (e.g. S1-U, S1-MME, etc.). In 3GPP, a conceptual link connecting two functions of different functional entities of an E-UTRAN and an EPC is defined as a reference point. Table 1 is a list of the reference points shown in FIG. 1. Various reference points may be present in addition to the reference points in Table 1 according to network structures.

TABLE 1

| Reference point | Description |
|---|---|
| S1-MME | Reference point for the control plane protocol between E-UTRAN and MME. |
| S1-U | Reference point between E-UTRAN and Serving GW for the per bearer user |
| | plane tunneling and inter eNB path switching during handover |
| S3 | It enables user and bearer information exchange for inter 3GPP access |
| | network mobility in idle and/or active state. This reference point can be used |
| | intra-PLMN or inter-PLMN (e.g. in the case of Inter-PLMN HO). |
| S4 | It provides related control and mobility support between GPRS Core and the |
| | 3GPP Anchor function of Serving GW. In addition, if Direct Tunnel is not |
| | established, it provides the user plane tunneling. |
| S5 | It provides user plane tunneling and tunnel management between Serving |
| | GW and PDN GW. It is used for Serving GW relocation due to UE mobility |
| | and if the Serving GW needs to connect to a non-collocated PDN GW for |
| | the required PDN connectivity. |
| S11 | Reference point between MME and an SGW |
| SGi | It is the reference point between the PDN GW and the packet data network. |
| | Packet data network may be an operator external public or private packet |
| | data network or an intra operator packet data network, e.g. for provision of |
| | IMS services. This reference point corresponds to Gi for 3GPP accesses. |

Among the reference points shown in FIG. 1, S2a and S2b correspond to non-3GPP interfaces. S2a is a reference point which provides reliable non-3GPP access and related control and mobility support between PDN GWs to a user plane. S2b is a reference point which provides related control and mobility support between the ePDG and the PDN GW to the user plane.

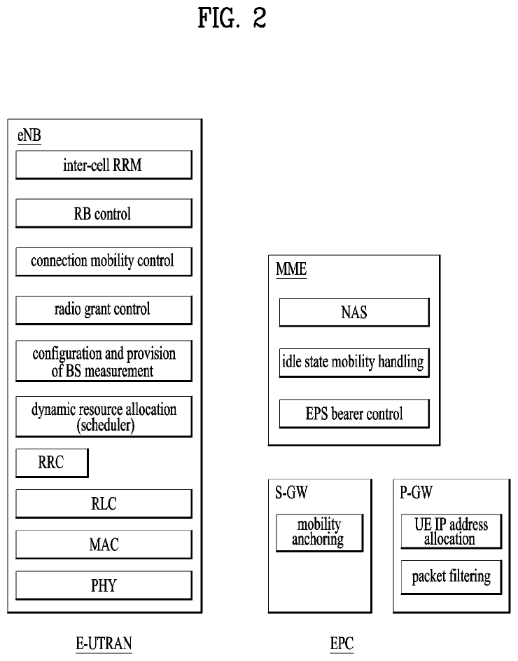

FIG. 2 is a diagram exemplarily illustrating architectures of a typical E-UTRAN and EPC.

As shown in the figure, while radio resource control (RRC) connection is activated, an eNodeB may perform routing to a gateway, scheduling transmission of a paging message, scheduling and transmission of a broadcast channel (BCH), dynamic allocation of resources to a UE on uplink and downlink, configuration and provision of eNodeB measurement, radio bearer control, radio admission control, and connection mobility control. In the EPC, paging generation, LTE_IDLE state management, ciphering of the user plane, SAE bearer control, and ciphering and integrity protection of NAS signaling.

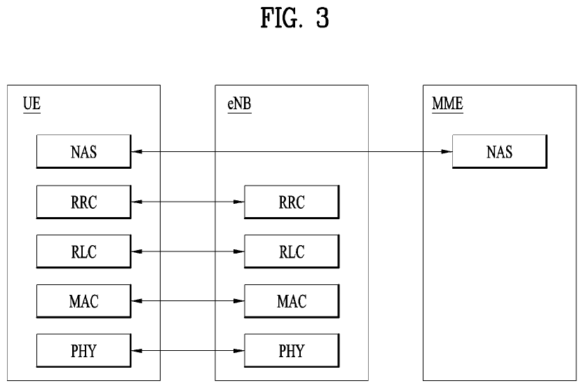

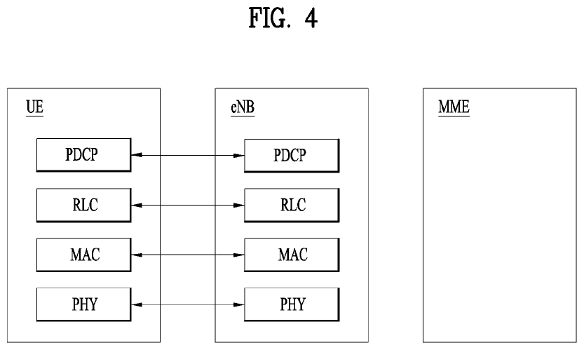

FIG. 3 is a diagram exemplarily illustrating the structure of a radio interface protocol in a control plane between a UE and a base station, and FIG. 4 is a diagram exemplarily illustrating the structure of a radio interface protocol in a user plane between the UE and the base station.

The radio interface protocol is based on the 3GPP wireless access network standard. The radio interface protocol horizontally includes a physical layer, a data link layer, and a networking layer. The radio interface protocol is divided into a user plane for transmission of data information and a control plane for delivering control signaling which are arranged vertically.

The protocol layers may be classified into a first layer (L1), a second layer (L2), and a third layer (L3) based on the three sublayers of the open system interconnection (OSI) model that is well known in the communication system.

Hereinafter, description will be given of a radio protocol in the control plane shown in FIG. 3 and a radio protocol in the user plane shown in FIG. 4.

The physical layer, which is the first layer, provides an information transfer service using a physical channel. The physical channel layer is connected to a medium access control (MAC) layer, which is a higher layer of the physical layer, through a transport channel. Data is transferred between the physical layer and the MAC layer through the transport channel. Transfer of data between different physical layers, i.e., a physical layer of a transmitter and a physical layer of a receiver is performed through the physical channel.

The physical channel consists of a plurality of subframes in the time domain and a plurality of subcarriers in the frequency domain. One subframe consists of a plurality of OFDM symbols in the time domain and a plurality of subcarriers. One subframe consists of a plurality of resource blocks. One resource block consists of a plurality of OFDM symbols and a plurality of subcarriers. A Transmission Time Interval (TTI), a unit time for data transmission, is 1 ms, which corresponds to one subframe.

According to 3GPP LTE, the physical channels present in the physical layers of the transmitter and the receiver may be divided into data channels corresponding to Physical Downlink Shared Channel (PDSCH) and Physical Uplink Shared Channel (PUSCH) and control channels corresponding to Physical Downlink Control Channel (PDCCH), Physical Control Format Indicator Channel (PCFICH), Physical Hybrid-ARQ Indicator Channel (PHICH) and Physical Uplink Control Channel (PUCCH).

The second layer includes various layers. First, the MAC layer in the second layer serves to map various logical channels to various transport channels and also serves to map various logical channels to one transport channel. The MAC layer is connected with an RLC layer, which is a higher layer, through a logical channel. The logical channel is broadly divided into a control channel for transmission of information of the control plane and a traffic channel for transmission of information of the user plane according to the types of transmitted information.

The radio link control (RLC) layer in the second layer serves to segment and concatenate data received from a higher layer to adjust the size of data such that the size is suitable for a lower layer to transmit the data in a radio interval.

The Packet Data Convergence Protocol (PDCP) layer in the second layer performs a header compression function of reducing the size of an IP packet header which has a relatively large size and contains unnecessary control information, in order to efficiently transmit an IP packet such as an IPv4 or IPv6 packet in a radio interval having a narrow bandwidth. In addition, in LTE, the PDCP layer also performs a security function, which consists of ciphering for preventing a third party from monitoring data and integrity protection for preventing data manipulation by a third party.

The Radio Resource Control (RRC) layer, which is located at the uppermost part of the third layer, is defined only in the control plane, and serves to configure radio bearers (RBs) and control a logical channel, a transport channel, and a physical channel in relation to reconfiguration and release operations. The RB represents a service provided by the second layer to ensure data transfer between a UE and the E-UTRAN.

If an RRC connection is established between the RRC layer of the UE and the RRC layer of a wireless network, the UE is in the RRC Connected mode. Otherwise, the UE is in the RRC Idle mode.

Hereinafter, description will be given of the RRC state of the UE and an RRC connection method. The RRC state refers to a state in which the RRC of the UE is or is not logically connected with the RRC of the E-UTRAN. The RRC state of the UE having logical connection with the RRC of the E-UTRAN is referred to as an RRC_CONNECTED state. The RRC state of the UE which does not have logical connection with the RRC of the E-UTRAN is referred to as an RRC_IDLE state. A UE in the RRC_CONNECTED state has RRC connection, and thus the E-UTRAN may recognize presence of the UE in a cell unit. Accordingly, the UE may be efficiently controlled. On the other hand, the E-UTRAN cannot recognize presence of a UE which is in the RRC_IDLE state. The UE in the RRC_IDLE state is managed by a core network in a tracking area (TA) which is an area unit larger than the cell. That is, for the UE in the RRC_IDLE state, only presence or absence of the UE is recognized in an area unit larger than the cell. In order for the UE in the RRC_IDLE state to be provided with a usual mobile communication service such as a voice service and a data service, the UE should transition to the RRC_CONNECTED state. A TA is distinguished from another TA by a tracking area identity (TAI) thereof. A UE may configure the TAI through a tracking area code (TAC), which is information broadcast from a cell.

When the user initially turns on the UE, the UE searches for a proper cell first. Then, the UE establishes RRC connection in the cell and registers information thereabout in the core network. Thereafter, the UE stays in the RRC_IDLE state. When necessary, the UE staying in the RRC_IDLE state selects a cell (again) and checks system information or paging information. This operation is called camping on a cell. Only when the UE staying in the RRC_IDLE state needs to establish RRC connection, does the UE establish RRC connection with the RRC layer of the E-UTRAN through the RRC connection procedure and transition to the RRC_CONNECTED state. The UE staying in the RRC_IDLE state needs to establish RRC connection in many cases. For example, the cases may include an attempt of a user to make a phone call, an attempt to transmit data, or transmission of a response message after reception of a paging message from the E-UTRAN.

The non-access stratum (NAS) layer positioned over the RRC layer performs functions such as session management and mobility management.

Hereinafter, the NAS layer shown in FIG. 3 will be described in detail.

The ESM (evolved Session Management) belonging to the NAS layer performs functions such as default bearer management and dedicated bearer management to control a UE to use a PS service from a network. The UE is assigned a default bearer resource by a specific packet data network (PDN) when the UE initially accesses the PDN. In this case, the network allocates an available IP to the UE to allow the UE to use a data service. The network also allocates QoS of a default bearer to the UE. LTE supports two kinds of bearers. One bearer is a bearer having characteristics of guaranteed bit rate (GBR) QoS for guaranteeing a specific bandwidth for transmission and reception of data, and the other bearer is a non-GBR bearer which has characteristics of best effort QoS without guaranteeing a bandwidth. The default bearer is assigned to a non-GBR bearer. The dedicated bearer may be assigned a bearer having QoS characteristics of GBR or non-GBR.

A bearer allocated to the UE by the network is referred to as an evolved packet service (EPS) bearer. When the EPS bearer is allocated to the UE, the network assigns one ID. This ID is called an EPS bearer ID. One EPS bearer has QoS characteristics of a maximum bit rate (MBR) and/or a guaranteed bit rate (GBR).

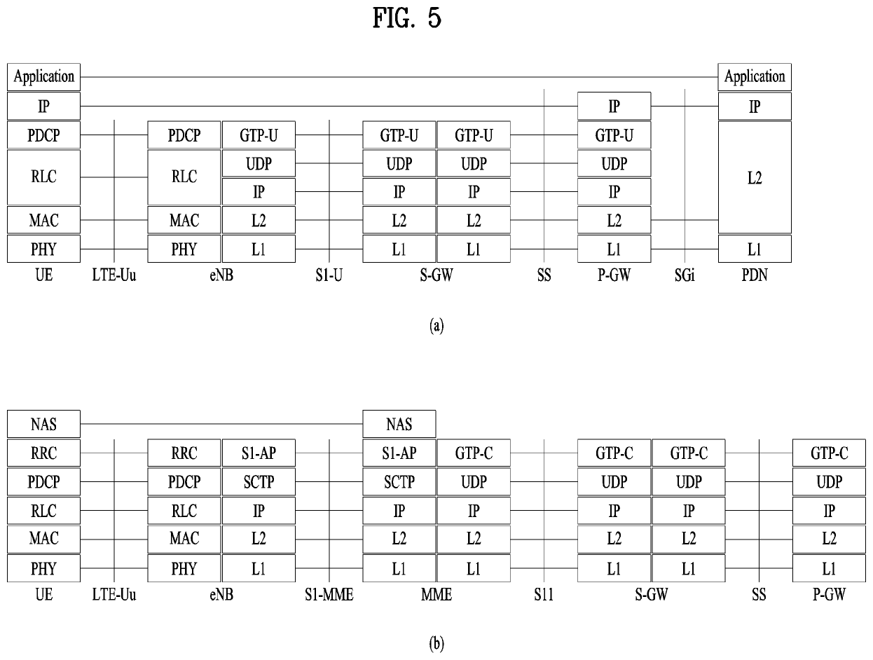

FIG. 5 is a diagram illustrating LTE protocol stacks for user and control planes. Specifically, FIG. 5(a) illustrates user plane protocol stacks between a UE, eNB, SGW, PGW, and PDN, and FIG. 5(b) illustrates control plane protocol stacks between a UE, eNB, MME, SGW, and PGW. Hereinafter, a description will be given of functions of key layers of the protocol stacks.

Referring to FIG. 5(a), a GTP-U protocol is used to forward user IP packets over S1-U/S5 interfaces. If a GTP tunnel is established for data forwarding during LTE handover, End Marker Packet is transferred as the last pack through the GTP tunnel.

Referring to FIG. 5 (b), an S1AP protocol is applied to an S1-MME interface. The S1AP protocol supports functions such as S1 interface management, E-RAB management, NAS signaling transmission, and UE context management. The S1AP protocol transfers an initial UE context to an eNB to set up an E-RAB(s) and then manages modification or release of the UE context. A GTP-C protocol is applied to S11/S5 interfaces. The GTP-C protocol supports the exchange of control information for generation, modification and termination of a GTP tunnel(s). In the case of the LTE handover, the GTP-C protocol generates forwarding tunnels.

The details of the protocol stacks and interfaces in FIGS. 3 and 4 can be applied to the same protocol stacks and interfaces in FIG. 5.

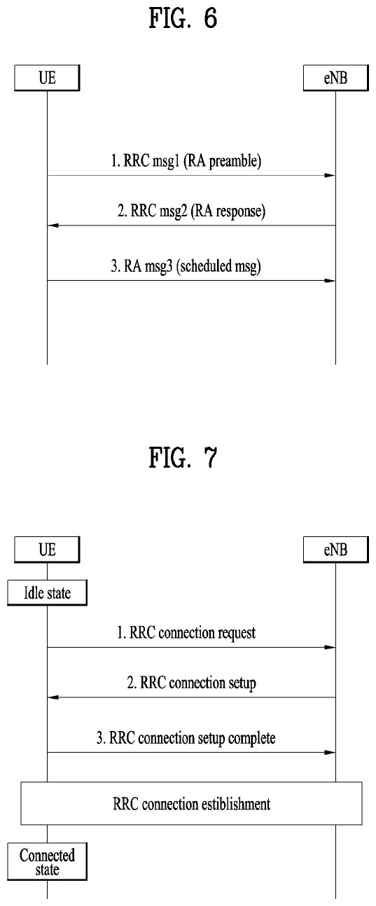

FIG. 6 is a flowchart illustrating a random access procedure in 3GPP LTE.

The random access procedure is performed for a UE to obtain UL synchronization with an eNB or to be assigned a UL radio resource.

The UE receives a root index and a physical random access channel (PRACH) configuration index from an eNodeB. Each cell has 64 candidate random access preambles defined by a Zadoff-Chu (ZC) sequence. The root index is a logical index used for the UE to generate 64 candidate random access preambles.

Transmission of a random access preamble is limited to a specific time and frequency resources for each cell. The PRACH configuration index indicates a specific subframe and preamble format in which transmission of the random access preamble is possible.

The random access procedure, particularly, contention-based random access procedure includes the following three steps. The messages transmitted in step 1, 2 and 3 can be referred to as msg1, msg2 and msg3.

>1. The UE transmits a randomly selected random access preamble to the eNodeB. The UE selects a random access preamble from among 64 candidate random access preambles and the UE selects a subframe corresponding to the PRACH configuration index. The UE transmits the selected random access preamble in the selected subframe.

>2. Upon receiving the random access preamble, the eNodeB sends a random access response (RAR) to the UE. The RAR is detected in two steps. First, the UE detects a PDCCH masked with a random access (RA)-RNTI. The UE receives an RAR in a MAC (medium access control) PDU (protocol data unit) on a PDSCH indicated by the detected PDCCH. The RAR includes timing advance (TA) information indicating timing offset information for UL synchronization, UL resource allocation information (UL grant information), and temporary UE identifier (e.g., temporary cell-RNTI, TC-RNTI, etc.).

>3. The UE can perform UL transmission according to the resource allocation information (i.e., scheduling information) and TA value included in the RAR. HARQ is applied to the UL transmission corresponding to the RAR. Thus, after performing the UL transmission, the UE may receive reception response information (e.g., PHICH) in response to the UL transmission.

FIG. 7 illustrates a connection procedure in a radio resource control (RRC) layer.

As shown in FIG. 7, the RRC state is set according to whether or not RRC connection is established. An RRC state indicates whether or not an entity of the RRC layer of a UE has logical connection with an entity of the RRC layer of an eNodeB. An RRC state in which the entity of the RRC layer of the UE is logically connected with the entity of the RRC layer of the eNodeB is called an RRC connected state. An RRC state in which the entity of the RRC layer of the UE is not logically connected with the entity of the RRC layer of the eNodeB is called an RRC idle state.

A UE in the Connected state has RRC connection, and thus the E-UTRAN may recognize presence of the UE in a cell unit. Accordingly, the UE may be efficiently controlled. On the other hand, the E-UTRAN cannot recognize presence of a UE which is in the idle state. The UE in the idle state is managed by the core network in a tracking area unit which is an area unit larger than the cell. The tracking area is a unit of a set of cells. That is, for the UE which is in the idle state, only presence or absence of the UE is recognized in a larger area unit. In order for the UE in the idle state to be provided with a usual mobile communication service such as a voice service and a data service, the UE should transition to the connected state.

When the user initially turns on the UE, the UE searches for a proper cell first, and then stays in the idle state. Only when the UE staying in the idle state needs to establish RRC connection, the UE establishes RRC connection with the RRC layer of the eNodeB through the RRC connection procedure and then performs transition to the RRC connected state.

The UE staying in the idle state needs to establish RRC connection in many cases. For example, the cases may include an attempt of a user to make a phone call, an attempt to transmit data, or transmission of a response message after reception of a paging message from the E-UTRAN.

In order for the UE in the idle state to establish RRC connection with the eNodeB, the RRC connection procedure needs to be performed as described above. The RRC connection procedure is broadly divided into transmission of an RRC connection request message from the UE to the eNodeB, transmission of an RRC connection setup message from the eNodeB to the UE, and transmission of an RRC connection setup complete message from the UE to eNodeB, which are described in detail below with reference to FIG. 7.

>1. When the UE in the idle state desires to establish RRC connection for reasons such as an attempt to make a call, a data transmission attempt, or a response of the eNodeB to paging, the UE transmits an RRC connection request message to the eNodeB first.

>2. Upon receiving the RRC connection request message from the UE, the ENB accepts the RRC connection request of the UE when the radio resources are sufficient, and then transmits an RRC connection setup message, which is a response message, to the UE.

>3. Upon receiving the RRC connection setup message, the UE transmits an RRC connection setup complete message to the eNodeB.

Only when the UE successfully transmits the RRC connection setup message, does the UE establish RRC connection with the eNodeB and transition to the RRC connected mode.

When new traffic occurs, the UE staying in the idle state performs a service request procedure to transition to an activate state where the UE can transmit/receive traffic. When an S1 connection is released and radio resources are not allocated due to traffic deactivation although the UE is registered in the network, that is, when the UE is in the EMM-Registered state and the ECM-Idle state, if there occurs traffic which the UE needs to transmit or the network needs to transmit to the UE, the UE may send a request for the service to the network. When the UE successfully completes the service request procedure, the UE transitions to the ECM-Connected state and then performs transmission/reception by establishing an ECM connection (i.e., RRC connection+S1 signaling connection) in the control plane and an E-RAB (i.e., DRB and S1 bearer) in the user plane. When the network desires to transmit traffic to a UE in the ECM-Idle state, the network transmits a Paging message to the UE to inform that there is traffic to be transmitted. By doing so, the UE may perform the service request procedure.

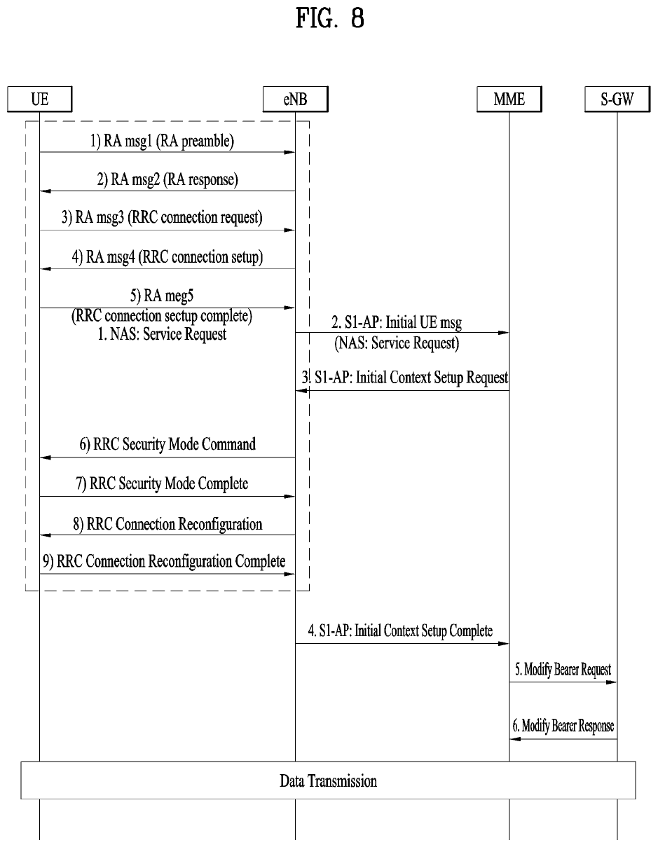

FIG. 8 is a diagram illustrating a UE triggered service request procedure.

Referring to FIG. 8, when there is traffic to be transmitted, a UE transmits an RRC Connection Request message to an eNB during a random access procedure, that is, by performing steps 1) to 3). When the eNB accepts the RRC connection request from the UE, the eNB transmits an RRC Connection Setup message to the UE. Upon receiving the RRC Connection Setup message, the UE transmits an RRC Connection Setup Complete message to the eNB by including a service request in the message. This will be described in detail with respect to a service request between a UE and MME.

>1. The UE sends NAS message Service Request to be transmitted to an MME by encapsulating it in an RRC message (e.g., RA msg5 in FIG. 8) toward the eNB.

>2. The eNB forwards the NAS message to the MME. The NAS message is encapsulated in S1-AP.

>3. The MME transmits an S1-Ap Initial Context Setup Request message to the eNB. In this step, radio and S1 bearers are activated for all activate EPS bearers. The eNB stores a security context, MME signaling connection ID, EPS bearer QoS(s), etc. in a UE context.

The eNB performs a radio bearer establishment procedure. Here, the radio bearer establishment procedure includes steps 6) to 9) illustrated in FIG. 8.

>4. The eNB transmits S1-AP message Initial Context Setup Complete to the MME.

>5. The MME transmits a Modify Bearer Request message for each PDN connection to an S-GW.

>6. The S-GW returns Modify Bearer Response to the MME in response to the Modify Bearer Request message.

Thereafter, traffic is transmitted/received via the E-RAB established by the service request procedure.

Recently, machine type communication (MTC) has come to the fore as a significant communication standard issue. MTC refers to exchange of information between a machine and an eNB without involving persons or with minimal human intervention. For example, MTC may be used for data communication for measurement/sensing/reporting such as meter reading, water level measurement, use of a surveillance camera, inventory reporting of a vending machine, etc. and may also be used for automatic application or firmware update processes for a plurality of UEs that share predetermined characteristics. In MTC, the amount of transmission data is small and data transmission or reception (hereinafter, transmission/reception) occurs occasionally. That is, in the case of a UE for MTC (hereinafter referred to as an MTC UE), it is efficient to reduce production cost and battery consumption according to the low data transfer rate due to such MTC features. Since the MTC UE has low mobility, the channel environment thereof remains substantially the same. If an MTC UE is used for metering, reading of a meter, surveillance, and the like, the MTC UE is very likely to be located in a place such as a basement, a warehouse, and mountain regions which the coverage of a typical eNB does not reach. Considering the purposes of the MTC UE, it is preferred to allow a signal for the MTC UE to have wider coverage than a signal for the conventional UE (hereinafter, a legacy UE).

It is expected that a number of devices will be wirelessly connected to each other through the Internet of Things (IoT). The IoT means internetworking of physical devices, vehicles, connected devices, smart devices, buildings, and other items with electronics, software, sensors, actuators, and network connectivity that enable these objects to collect and exchange data. In other words, the IoT refers to a network of physical objects, machines, people, and other devices that enable connectivity and communication for the purpose of exchanging data for intelligent applications and services. The IoT allows objects to be sensed and controlled remotely through existing network infrastructures, thereby providing opportunities for the direct integration between the physical and digital worlds, which result in improving efficiency, accuracy and economic benefits. Particularly, in the present invention, the IoT using the 3GPP technology is referred to as cellular IoT (CIoT). In addition, the CIoT that transmits/receives IoT signals using a narrowband (e.g., a frequency band of about 200 kHz) is called NB-IoT.

The CIoT is used to monitor traffic transmitted over a relatively long period, e.g., from a few decades to a year (e.g., smoke alarm detection, power failure notification from smart meters, tamper notification, smart utility (gas/water/electricity) metering reports, software patches/updates, etc.) and support UT′ devices characterized as ultra-low complexity, power limitation and low data rates.

According to the prior art, a UE in the EMM-Idle state should establish a connection with the network to transmit data. To this end, the UE should successfully complete the service request procedure illustrated in FIG. 8, but it is not suitable for the CIoT that requires optimized power consumption for the low data rate. To transmit data to an application, two types of optimization: user plane CIoT EPS optimization and Control Plane CIoT EPS optimization has been defined for the CIoT in the EPS.

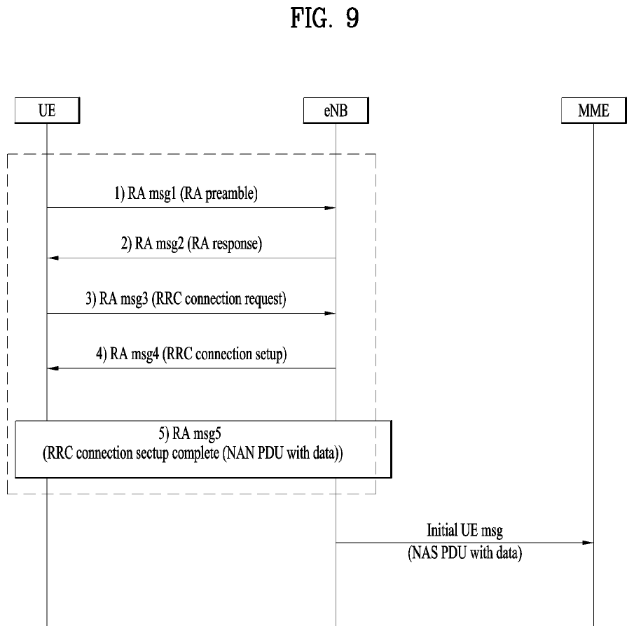

FIG. 9 is a diagram illustrating in brief a data transmission procedure in accordance with Control Plane CIoT EPS optimization regarding radio signals.

According to the Control Plane CIoT EPS optimization, UL data is transferred from an eNB (CIoT RAN) to an MME. Thereafter, the UL data may be transmitted from the MME to a P-GW through an S-GW. Through these nodes, the UL data is forwarded to an application server (i.e., CIoT services). DL data is transmitted through the same path in the opposite direction. In the case of a Control Plane CIoT EPS optimization solution, there is no setup data radio bearer, but data packets are transmitted through signaling bearers. Thus, this solution is most suitable for transmission of infrequent small data packets.

When a UE and MME use the Control Plane CIoT EPS optimization is applied, the UE and MME may transfer IP or non-IP data through NAS signaling depending on data types selected for a PDN connection supported at PDN connection establishment.

The Control Plane CIoT EPS optimization can be achieved by using NAS transport capabilities of RRC and S1-AP protocols and data transfer through GTP (Evolved General Packet Radio Service (GPRS) Tunneling Protocol) tunnels between an MME and an S-GW and between an S-GW and a P-GW.

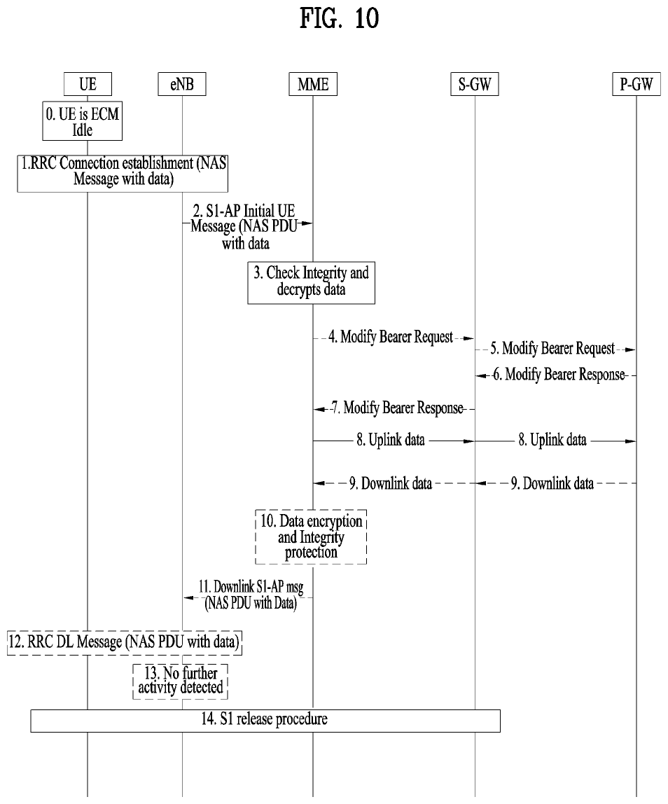

FIG. 10 is a diagram illustrating an overall procedure for transferring data in an EPS system when Control Plane CIoT EPS optimization is used. Specifically, FIG. 10 shows a procedure for transferring mobile-originated data according to the Control Plane CIoT EPS optimization in detail.

>0. The UE is in the ECM-IDLE state.

>1. The UE establishes an RRC connection and transmits, as part of it, UL data, which is encrypted and integrity-protected, in a NAS message. The UE can also indicate, through release assistance information in the NAS message, whether DL data transmission (e.g. acknowledgements or responses to UL data) subsequent to the UL Data transmission is expected or not. Upon receiving DL data, the UE may indicate whether an S1 connection should be released.

>2. The NAS message transmitted in step 1 is relayed to the MME by the eNB using a S1-AP Initial UE message.

>3. The MME checks the integrity of the incoming NAS message PDU and decrypts data contained in the NAS message. The MME also decides at this stage whether the data transfer will use SGi or SCEF-based delivery.

>4. The MME transmits a Modify Bearer Request message (MME address, MME TEID DL, Delay Downlink Packet Notification Request, and Modify Bearer Request message including RAT type) to the S-GW. The S-GW is now able to transmit DL data to the UE. If the PDN GW requested a location of the UE and/or User CSG Information and if the UE's location and/or User CSG Information has changed, the MME also includes a User Location Information IE and/or a User CSG Information IE in this message. If a Serving Network IE has changed compared to the last reported Serving Network IE, the MME also includes the Serving Network IE in this message. If UE Time Zone has changed compared to the last reported UE Time Zone, the MME includes the UE Time Zone IE in this message.

>5. If the RAT type has changed compared to the last reported RAT type or if the UE's location and/or Information IEs and/or UE Time Zone and Serving Network ID are present in step 4, the S-GW transmits the Modify Bearer Request message (RAT type) to the PDN GW. If the User Location Information IE and/or User CSG Information IE and/or Serving Network IE and/or UE Time Zone are present in step 4, they are also included.

If the Modify Bearer Request message is not sent because of above reasons and the PDN GW charging is paused, the S-GW transmits a Modify Bearer Request message with PDN Charging Pause Stop Indication to inform the PDN GW that the charging is no longer paused. Other IEs are not included in this message.

>6. The PDN GW sends Modify Bearer Response to the S-GW.

>7. The S-GW returns the Modify Bearer Response (an S-GW address and a TEID for uplink traffic) to the MME in response to the Modify Bearer Request message.

>8. The MME transmits UL data to the P-GW.

>9. If the MME recognizes, based on release assistance information from the UE in step 1, that any DL data is not expected, the MME immediately releases the connection, and therefore step 14 is executed. Otherwise, DL data may arrive at the P-GW, and the P-GW transmits the DL data to the MME. If no data is received, steps 11 to 13 may be skipped. If the RRC connection is active, the UE can still transmit UL data through NAS messages which are carried in a S1AP Uplink message (not shown in FIG. 10). In addition, the UE may provide the release assistance information together with UL data at any time.

>10. If DL data is received in step 9, the MME encrypts the DL data and performs integrity-protection of the encrypted DL data.

>11. If step 10 is executed, DL data is encapsulated in a NAS message and transmitted to the eNB in a S1-AP DL message. If the release assistance information was received with UL data and it indicated a request to release the RRC connection upon DL data reception, the MME also includes, in the S1-AP message, an indication indicating that the eNB should release the RRC connection after successfully transmitting data to the UE.

>12. The eNB transmits RRC DL data including the DL data encapsulated in a NAS PDU. When DL data was received, if a request to tear down the RRC connection was included in the release assistance information, which was sent via the S1-AP message in step 11, the RRC DL data may include a request to immediately release the RRC connection. If so, step 14 is immediately executed.

>13. If no NAS activity exists for a while, the eNB starts an S1 release procedure in step 14.

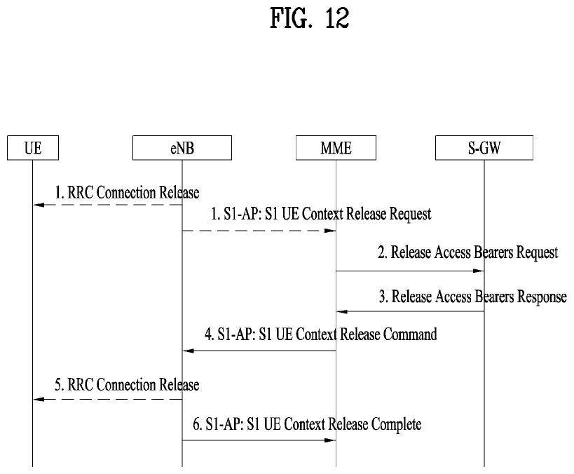

>14. The S1 release procedure is performed as described in FIG. 12.

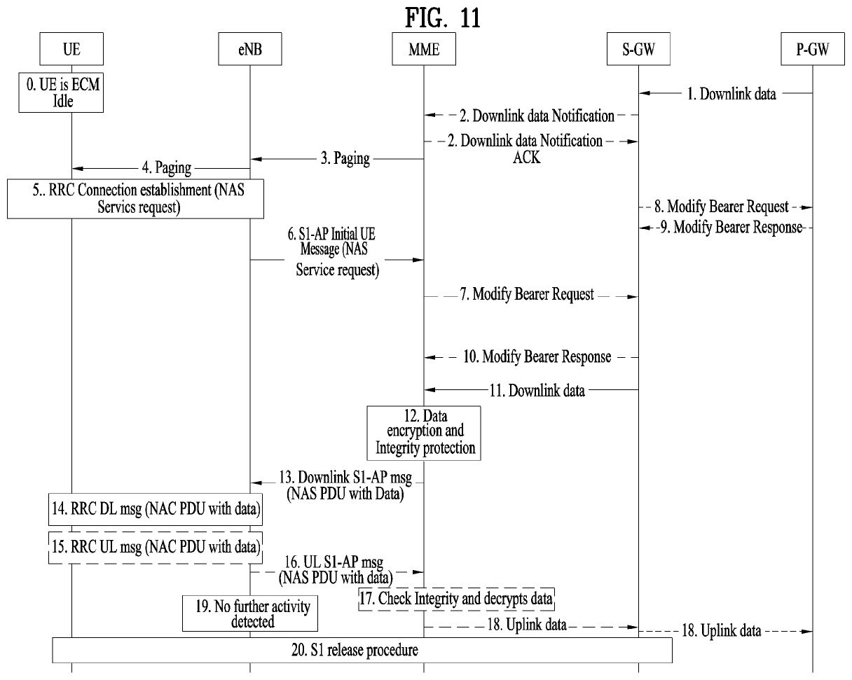

FIG. 11 is a diagram illustrating an overall procedure for transferring mobile-terminated data in an EPS system according to Control Plane CIoT EPS optimization.

>0. The UE is attached to the EPS and in the ECM-Idle mode.

>1. When the S-GW receives a DL data packet/control signaling for a UE, which is known as not user plane connected (i.e. S-GW context data indicates no DL user plane TEID for the MME), the S-GW buffers the DL data packet and identifies which MME is serving the UE.

>2. The S-GW transmits a Downlink Data Notification message (including Allocation and Retention Priority (ARP) and an EPS Bearer ID) to the MME having control plane connectivity with the S-GW for the given UE. The ARP and EPS Bearer ID are always set in Downlink Data Notification. The MME responds to the S-GW using a Downlink Data Notification Ack message.

>3. If the UE is registered in the MME and considered reachable, the MME sends a Paging message (NAS ID for paging, TAI(s), UE identity based DRX index, paging DRX length, list of CSG IDs for paging, paging priority indication) to each eNB belonging to the tracking area(s) in which the UE is registered.

>4. If eNBs receive the Paging messages from the MME, the UE is paged by the eNBs.

>5-6. If the UE is in the ECM-IDLE state, after receiving paging indication, the UE sends a UE Triggered Service Request NAS message over RRC Connection Request and S1-AP Initial messages.

>7. The MME transmits a Modify Bearer Request message (MME address, MME TEID DL, Delay Downlink Packet Notification Request, and RAT type) to the S-GW. The S-GW is now able to transmit DL data to the UE. If the PDN GW requested a location of the UE and/or User CSG Information and if the UE's location and/or User CSG Information has changed, the MME also includes a User Location Information IE and/or a User CSG Information IE in this message. If a Serving Network IE has changed compared to the last reported Serving Network IE, the MME also includes the Serving Network IE in this message. If UE Time Zone has changed compared to the last reported UE Time Zone, the MME includes the UE Time Zone IE in this message.

NOTE: if the currently used RAT is NB-IoT, it is reported as an RAT different from E-UTRA.

>8. If the RAT type has changed compared to the last reported RAT type or if the UE's location and/or Information IEs and/or UE Time Zone and Serving Network ID are present in step 7, the S-GW transmits the Modify Bearer Request message (including the RAT type) to the PDN GW. If the User Location Information IE and/or User CSG Information IE and/or Serving Network IE and/or UE Time Zone are present in step 7, they may also be included. Other IEs are not included in this message.

>9. The PDN GW transmits Modify Bearer Response to the S-GW.

>10. The S-GW returns the Modify Bearer Response (S-GW address and TEID for uplink traffic) to the MME as a response to the Modify Bearer Request message.

>11. Buffered DL data is transmitted by the SGW to the MME.

>12-13. The MME encrypts the DL data, performs integrity protection of the encrypted DL data, and then sends it to the eNB using a NAS message carried by a DL S1-AP message.

>14. A NAS PDU with data is delivered to the UE via a DL RRC message.

>15. While an inactivity timer is running, UL and DL data can be further transmitted using NAS PDUs. It can be seen that in step 17, UL data transmission is performed using an UL RRC message encapsulating the NAS PDU with data. The UE may provide release assistance information with UL data in the NAS message at any time.

>16. The NAS PDU with data is transmitted to the MME via a UL S1-AP message.

>17. The integrity of the data is checked, and it is decrypted.

>18. The MME transmits UL data to the P-GW through the S-GW and executes an action related to the presence of release assistance information after performing behavior for mobile-originated (MO) data transfer.

>19. If no NAS activity exists for a while, the eNB detects inactivity and executes step 20.

>20. The eNB starts an eNB initiated S1 release procedure as shown in FIG. 12.

FIG. 12 is a diagram for explaining an S1 release procedure.

The S1 release procedure is used to release a logical S1-AP (Application Protocol) signaling connection (over S1-MME) and all S1 bearers (in S1-U) for a UE. In Control Plane CIoT EPS optimization, the S1 release procedure releases S11 instead of the S1-U bearer. The S1 release procedure will allow both the UE and MME to move the UE from ECM-CONNECTED to ECM-IDLE and an eNB to delete all UE related context information. When the S1-AP signaling connection is lost, for example, due to signaling transport loss or because of eNB or MME failure, the S1 release procedure is locally performed by the eNB and MME. When the S1 release procedure is locally performed by the eNB and MME, each node locally performs its own actions as described in the following procedure flow without using or relying on direct signaling between the eNB and MME.

From the perspective of a network, the S1 release means releasing S1 signaling and RRC connections in the control plane and releasing a DL S1 bearer and a data radio bearer (DRB) in the user plane. However, from the perspective of a UE, it means losing its RRC connection and DRB in the control and user planes, respectively. Once the S1 connection is released, an ECM connection between a UE and MME is lost, and all contexts associated with the UE are deleted at an eNB. Thereafter, the UE transitions from the ECM-CONNECTED state to the ECM-IDLE state at the UE and MME, but the UE remains in the EMM-REGISTERED state even after the transition.

The S1 release procedure is initiated by either the eNB or MME. For example, the eNB initiates the S1 release procedure because of the following causes: O&M Intervention, Unspecified Failure, User Inactivity, Repeated RRC signalling Integrity Check Failure, Release due to UE generated signalling connection release, CS Fallback triggered, Inter-RAT Redirection, etc. On the other hand, the MME initiates the S1 release procedure because of the following causes: authentication failure, detach, not allowed CSG cell (e.g., a case in which the CSG ID of the currently used CSG cell expires or a case in which it is removed from the CSG subscription data), etc. FIG. 12 shows both the eNB initiated S1 release procedure and MME initiated S1 release procedure.

>1a. In certain cases, the eNB may release the UE's signaling connection before or in parallel to requesting the MME to release an S1 context. For example, the eNB may initiate RRC Connection Release for circuit switch (CS) fallback by redirection.

>1b. If the eNB detects a need to release the UE's signaling connection and all radio bearers for the UE, the eNB sends an S1 UE Context Release Request (Cause) message to the MME. In this case, a cause may be the reason for the release (e.g. O&M intervention, unspecified failure, user inactivity, repeated integrity checking failure, or release due to UE generated signalling connection release).

NOTE: Step 1 is only performed when the eNB initiated S1 release procedure is considered. That is, when the MME initiated S1 release procedure is considered, step 1 is not performed but MME initiated S1 release procedure DMS step 2 starts.

>2. The MME sends a Release Access Bearers Request (including Abnormal Release of Radio Link Indication) message to the S-GW that requests the release of all S1-U bearers for the UE or the S11 in the Control Plane CIoT EPS optimization. This message is triggered by either an S1 Release Request message from the eNB or another MME event. If the S1 release procedure is due to abnormal release of the radio link, the Abnormal Release of Radio Link Indication is included.

>3. The S-GW releases eNB-related information (e.g., address and TEIDs) or MME-related information in the Control Plane CIoT EPS optimization for the UE and responds with a Release Access Bearers Response message to the UE. In this case, other elements of the UE's S-GW context are not affected. The S-GW retains an S1-U configuration that the S-GW allocated for the UE's bearers. If downlink packets arrive for the UE, the S-GW starts buffering the downlink packets received for the UE and initiating a Network Triggered Service Request procedure. In the Control Plane CIoT EPS optimization, downlink data triggers mobile terminated data transport in NAS signaling.

NOTE: If the feature has been enabled on the corresponding PDN, any received indication regarding the Abnormal Release of Radio Link may be used by the S-GW in subsequent decisions to trigger a PDN charging pause based on operator policy.

>4. The MME releases S1 by transmitting an S1 UE Context Release Command (Cause) message to the eNB.

>5. If the RRC connection is not already released, the eNB sends a RRC Connection Release message to the UE in Acknowledged Mode.

>6. The eNB confirms the S1 release by returning an S1 UE Context Release Complete message (including ECGI and TAI) to the MME. By doing so, the signaling connection for the UE, which was established between the MME and eNB, is released. For example, this step may not be delayed in situations where the UE does not acknowledge the RRC connection release, and it is performed promptly after step 4.

The eNB may include information on cells and eNBs recommended for paging in the S1 UE Context Release Complete message. If available, the MME may store this information to use it when paging the UE.

The MME deletes any eNB-related information (e.g., “eNodeB Address in Use for S1-MME”, “MME UE S1 AP ID” and “eNB UE S1AP ID”) from a UE's MME context but retains the rest of the UE's MME context including the S-GW's S1-U configuration information (e.g., address and TEIDs). In addition, all non-GBR EPS bearers established for the UE are preserved in the MME and S-GW.

If the cause of S1 release is User I Inactivity and Inter-RAT Redirection, the MME preserves GBR bearers. On the other hand, if the cause of S1 release is CS Fallback triggered, the details about bearer handling defined in 3GPP TS 23.272 could be applied. Otherwise, for example, “Radio Connection with UE Lost”, “S1 signalling connection lost”, and “eNodeB failure”, the MME triggers an MME Initiated Dedicated Bearer Deactivation procedure for the GBR bearer(s) of the UE after the S1 Release procedure is completed.

NOTE: An EPC does not support the GPRS preservation feature for setting the maximum bit rate (MBR) for GBR bearers to zero.

If a local IP address (LIPA) is activated for a PDN connection, an HeNB informs a collocated L-GW through internal signal that a direct user plane path to the HeNB is released. After the direct user plane path is released, if downlink packets arrive for the UE, the L-GW forwards the first packet to the S-GW on an S5 tunnel in order to initiate the Network Triggered Service Request procedure.

The process in which the eNB sends the RRC Connection Release message to the UE in steps 1 to 5 of the S1 release procedure can be performed as described in section 5.3.8, section 5.3.9 and/or section 5.3.12 of 3GPP TS 36.331.

The details of the S1 release in FIG. 12 can be found in section 5.3.5 of 3GPP TS 23.401.

According to Mobile Originated Data transport in Control Plane CIoT operation, when a UE expects DL data transmission (ACK or response) after transmitting UL data, the UE informs an MME of the fact that the UE expects the DL data transmission through release assistance information in a NAS message as shown in step 1 of FIG. 10 or step 15 of FIG. 11. When the UE receives the DL data, whether an S1 connection needs to be released may be indicated.

Referring to step 9 of FIG. 10, when the release assistance information contains an IE indicating that ‘the UE does not expect any DL data transmission after transmitting UL data’, the MME performs S1 release immediately after receiving it. In other words, upon receiving this UL data message, the MME transmits UL data transmission and performs the S1 release in step 8.

When DL data is received, steps 10 and 11 of FIG. 10 are performed (when the release assistance information contains the fact that the UE expects DL data transmission after transmitting UL data). When the MME receives DL data, the MME may request an eNB to perform the S1 release procedure after successfully transmitting the received DL data.

Meanwhile, when the UE expects the DL data transmission (e.g., ACK or response) after transmitting the UL data so that the UE informs the MME of this through the release assistance information in the NAS message, the following problems may occur.

Problem 1) If the MME receives DL data in step 9 of FIG. 10, the MME is unable to know whether the received DL data is ACK or response in response to the UL data transmitted in step 1 of FIG. 10.

Thus, even when the DL data received in step 10 is not the ACK or response in response to the UL data transmitted in step 1, the S1 release procedure described in FIG. 12 is performed in step 14 of FIG. 10 according to steps 11 and 12 of FIG. 10.

Referring to FIG. 12, the eNB transmits the S1 Connection Release message to the UE in step 1. When the message is not transmitted in step 1, the eNB transmits it to the UE in step 5. When receiving the S1 Connection Release message in step 1 or 5 of FIG. 12, the UE may recognize that the S1 release procedure will be performed. However, the UE that expects reception of DL data still does not receive the ACK or response to the UL data, there is no way for the UE to stop the S1 release procedure. That is, when the S1 connection is released even though the UE does not receive the ACK or response to the UL data, the following problems may occur after the S1 connection is released.
A. After the S1 connection is released, the UE should perform step 1 of FIG. 10 again to receive the ACK or response to the UL data or retransmit the UL data.
B. If DL data corresponding to the ACK of the UL data, which was transmitted in step 1, is transmitted after the S1 release procedure is terminated, the procedure for transferring mobile-terminated data according to the Control Plane CIoT optimization described above in FIG. 11 needs to be performed.

In both cases A and B, signaling overhead may occur.

Problem 2) When no DL data is received, the eNB starts the S1 release procedure according to step 13 of FIG. 10.

While performing the S1 release procedure, the eNB transmits the RRC Connection Release message to the UE. If the RRC Connection Release message is received, the UE cannot stop the S1 release procedure even though the UE still does not receive the ACK or response. Once the S1 connection is released due to failure in stopping the S1 release, the following problems may occur.
A. After the S1 connection is released, the UE should perform step 1 of FIG. 10 again to retransmit the UL data.
B. If DL data corresponding to the ACK of the UL data, which was transmitted in step 1, is transmitted, the procedure for transferring mobile-terminated data according to the Control Plane CIoT optimization described above in FIG. 11 needs to be performed.

In both cases A and B, signaling overhead may occur.

Problem 3) When DL data is not received as mentioned in problem 2, the eNB performs the S1 release procedure as shown in step 13 of FIG. 10. However, when the expected ACK or response is not received, the time for which the eNB checks inactivity may not be suitable for determining whether to perform the S1 release procedure. In addition, considering the fact that an inactivity timer is running longer than another timer(s), the time required for the eNB to complete the S1 release procedure after starting the S1 release based on the time for checking the inactivity may significantly increase. As the time required for completing the S1 release procedure increases, the burden imposed to the network to maintain the S1 connection increases.

Problem 4) When the eNB initiates the S1 release by itself, the eNB may not recognize that the UE expects DL data.

The eNB initiated S1 release may be divided into two cases: a first case in which the MME triggers the S1 release so that the eNB initiates the S1 release; and a second case in which the eNB triggers and initiates the S1 release by itself. When the eNB triggers the S1 release by itself, the eNB cannot recognize that the UE expects a DL packet in response to a UL packet, which was sent in a NAS message, because the eNB cannot read the NAS message. Thus, when the eNB initiates the S1 release by itself (for reasons such as UE inactivity and the like), the eNB may perform the conventional S1 release procedure because it cannot recognize the situation where a DL packet is expected.

Moreover, problems 1, 2, 3, and 4 may occur during the mobile-terminated data transfer procedure in the Control Plane CIoT optimization (for example, after step 13 of FIG. 11) described above with reference to FIG. 11.

Accordingly, the present invention proposes an enhanced S1 release procedure(s) for reducing the signaling overhead and burdens of maintaining contexts, which occur when an S1 release procedure is performed after a UE transmits UL data in a NAS message in the CIoT network.

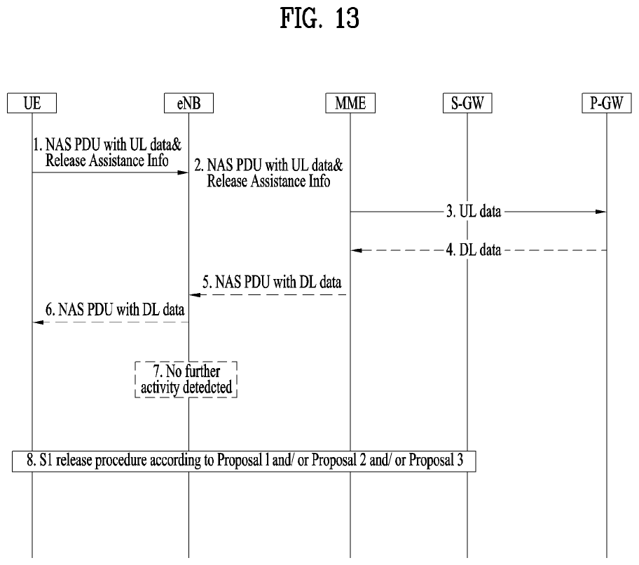

FIG. 13 is a diagram illustrating in brief an S1 release procedure according to the present invention when Control Plane CIoT optimization is applied.

Proposals 1, 2, and 3 of the present invention, which will be described later, can be applied independently or by combining two or more of them together. In addition, the S1 release procedure in step 14 of FIG. 10 and the S1 release procedure in step 20 of FIG. 11 can be performed according to proposals 1, 2, and 3 of the present invention.

Hereinafter, a description will be briefly given of the S1 release procedure according to the present invention when the Control Plane CIoT optimization is applied.

Steps 1, 2, 3, 4, 5, 6, and 7 in FIG. 13 may correspond to steps 1, 2, 8, 9, 11, 12, and 13 described above in FIG. 10, respectively. In addition, steps 1, 2, 3, and 7 in FIG. 13 may also correspond to steps 15, 16, 17, and 19 mentioned in FIG. 11, respectively. In step 18 of FIG. 11, since the MME transmits UL data to the P-GW through the S-GW and executes an action related to the presence of release assistance information after performing behavior for mobile-originated (MO) data transfer, DL data for the mobile-originated data of FIG. 11 can be transferred to the UE according to steps 9 to 12 of FIG. 10.

When the cause of S1 release is present, the S1 release according to the present invention can be performed according to proposals 1, 2, and/or 3, which will be described later, rather than the S1 release procedure in step 8 of FIG. 12.

Proposal 1) Proposal for solving problems 1, 2, and/or 4

Proposal 1-A) ENB initiated S1 release procedure

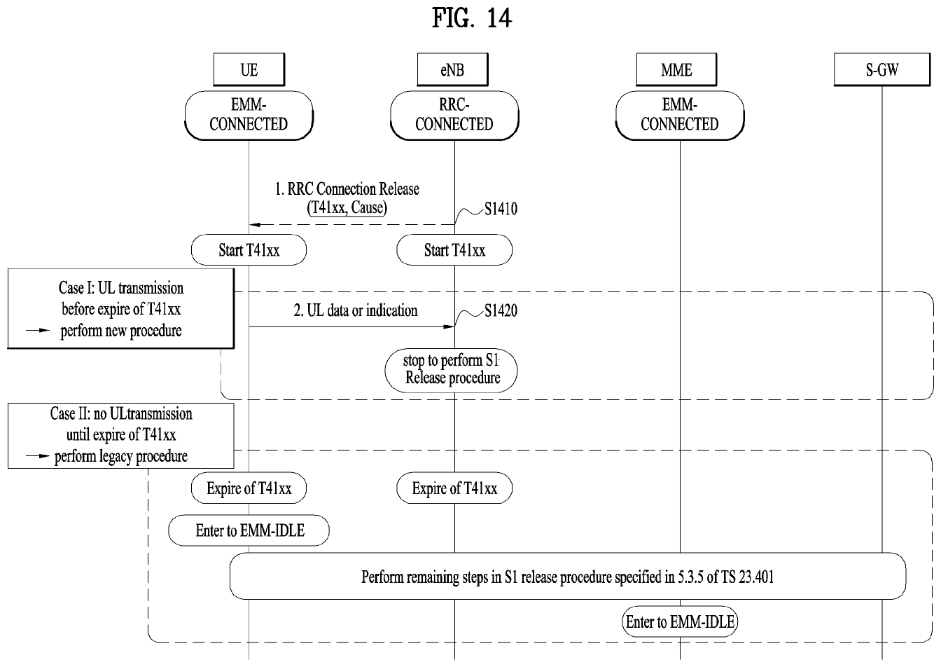

FIG. 14 is a diagram illustrating an exemplary S1 connection release procedure according to a proposal of the present invention. In particular, FIG. 14 shows the eNB initiated S1 release procedure according to proposal 1-A.

According to the S1 release procedure of FIG. 12, the eNB transmits the RRC Connection Release message to the UE in steps 1 and 5. The details of RRC Connection Release can be found in section 5.3.8 of 3GPP TS 36.331. The operation proposed in the present invention, that is, steps 1 and/or 1-1 can be performed during step 1 of the S1 release procedure described above with reference to FIG. 12 (or section 5.3.8.2 of 3GPP TS 36.331). The details of proposal 1-A will be described with reference to FIG. 14.

> Step 1. While transmitting the RRC Connection Release message to the UE, the eNB sets timer T41xx to a predetermined value and starts it [S1410]. The eNB does not perform RRC Connection Release until expiration of timer T41xx. That is, the eNB stands by without performing other operations in the S1 release procedure until timer T41xx expires. For example, the eNB stands by without performing other operations in the procedure including transmission of the UE Context Release Request message through the S1-AP in step 1 of FIG. 12.

In this case, the UE may know the value of timer T41xx. The value of timer T41xx may be sent to the network in a NAS message or RRC message, or it may be pre-configured. In the case of using the RRC message, the value of timer T41xx may be contained in the RRC Connection Release message.

In step 1, a cause may be included in the RRC Connection Release message. For example, as the cause included in the RRC Connection Release message, “arrival of expected DL packet” or an existing cause may be used. The existing cause will be described later. In addition, “no arrival of expected DL packet” may be defined as a new cause. When the RRC Connection Release message including the existing cause is received, the UE may be configured to interpret the existing cause as “no arrival of expected DL packet”.

> Step 1-1. Depending on whether the UE is in case A or B upon receiving the RRC Connection Release message, the UE may transmit the following messages to the network.

A. A Case in which the UE does not Receive ACK/Response to the Previously Transmitted UL Data

Case A includes a case in which the UE does not receive ACK/response even though the UE indicates the necessity of the ACK/response through the release assistance information in the NAS message in step 1 of FIG. 10 (step 15 of FIG. 11 or step 1 of FIG. 13).

B. A Case in which the UE has UL Data to be Transmitted

Case B includes a case in which the UE does not receive ACK/response even though the UE indicates the necessity of the ACK/response through the release assistance information in the NAS message in step 1 of FIG. 10 (step 15 of FIG. 11 or step 1 of FIG. 13) so that the UE decides to retransmit the previous UL data or a case in which the UE has new data.

If UL transmission occurs before the expiration of timer T41xx (case I of FIG. 14), for example, in case A or B, the UE transmits the following messages [S1420].
The UE includes UL data in a NAS message and transmits it to the network again.
>> The UL data may correspond to the previous UL data of which the ACK/response has not received or new UL data.
The UE transmits, to the network, an indication (or information) indicating that the UE waits for reception of a message (ACK or response) or an indication for requesting the network to maintain the S1 connection rather than releasing the connection.
>> The indication may be transmitted to the eNB in an RRC message, or it may be transmitted to the MME in a NAS message.
>> When receiving the corresponding message, the eNB (or MME) may include the indication in an S1-AP message to transmit it to the MME (or eNB). When the indication is contained in an RRC message, the eNB may include the indication contained in the RRC message in an S1-AP message to transmit it to the MME because the eNB can read the RRC message. When the indication is contained in a NAS message encapsulated in an RRC message, the eNB includes the NAS message in an S1-AP message to forward the NAS message to the MME because the eNB has no NAS layer. Then, after reading the indication contained in the NAS message, the MME may include the read indication in an S1-AP message to transmit the indication to the eNB.
>> Upon receiving the S1-AP message including the indication, the eNB (or MME) operates as if it receives the UL data in the NAS message. For example, the eNB resets an inactivity timer to the initial value and then starts it after receiving a message.

If there is no UL transmission until the expiration of timer T41xx (case II of FIG. 14), the UE enters the EMM-Idle state after the expiration of timer T41xx, and then the conventional S1 release procedure (defined in section 5.3.5 of 3GPP TS 23.401) may be performed. According to proposal 1-A, when the eNB intends to initiate the S1 release, the eNB may perform the delayed S1 release procedure after the expiration of timer T41xx instead of performing the S1 release procedure immediately after transmitting the RRC Connection Release message to the UE.

Proposal 1-B) MME Initiated S1 Release Procedure

The operation proposed in the present invention can be applied to the following case:

A case when it is applied to the CIoT network; or

A case when the UE indicates the necessity of ACK or response through the release assistance information in the NAS message.

Regarding the MME initiated S1 release procedure in the S1 release procedure of FIG. 12 (or section 5.3.9 of 3GPP TS 36. 331), the operation proposed in the present invention can be performed as follows.

In the S1 release procedure described with reference to FIG. 12, when the MME initiates the S1 release procedure, the MME places step 2 of FIG. 12 after step 6 of FIG. 12 and then determines, in step 6 of the present proposal, whether to perform step 2 of the S1 release procedure described in FIG. 12 according to the UE's response transferred in step 5 of FIG. 12. Details will be described in the following.

> Step 4. The MME transmits the value of timer T41 aa to the eNB using an S1 UE Context Release Command (Cause) message. The MME sets timer T41aa to a predetermined value and starts it. Until expiration of timer T41aa, the MME stands by without transmitting the Release Access Bearers Request message (which is supposed to be transmitted to the S-GW in step 2 of the S1 release procedure of FIG. 12).

In this case, the UE may know the value of timer T41aa. The value of timer T41 aa may be transmitted from the network in a NAS message or RRC message, or it may be pre-configured. In the case of the NAS message, the T41aa value may be included in an Attach Accept message or TAU Accept message and then transmitted to the UE. In the case of the RRC message, the T41aa value may be contained in an RRC Connection Release message.

When transmitting the S1 UE Context Release Command message, the MME sets the cause to “ACK/response is received” if ACK/response to UL data is received or sets the cause to “ACK/response is not received” if it is not received.

> Step 5. When transmitting an RRC Connection Release message, the eNB forwards the cause in the S1 UE Context Release Command message to the UE. Other operations performed by the eNB are the same as those in step 1 of proposal 1-A.

> Step 6. Upon receiving the RRC Connection Release message, the UE operates according to step 1-1 of proposal 1-A.

> Step 7. Even if a NAS message is received from the UE, the MME does not transmit a Release Access Bearers Request message to the S-GW until the expiration of timer T41 aa.

According to proposal 1-B, the MME may transmit the timer value when initiating the S1 release procedure, and until the expiration of the timer, the MME and S-GW may not perform operation for the S1 release.

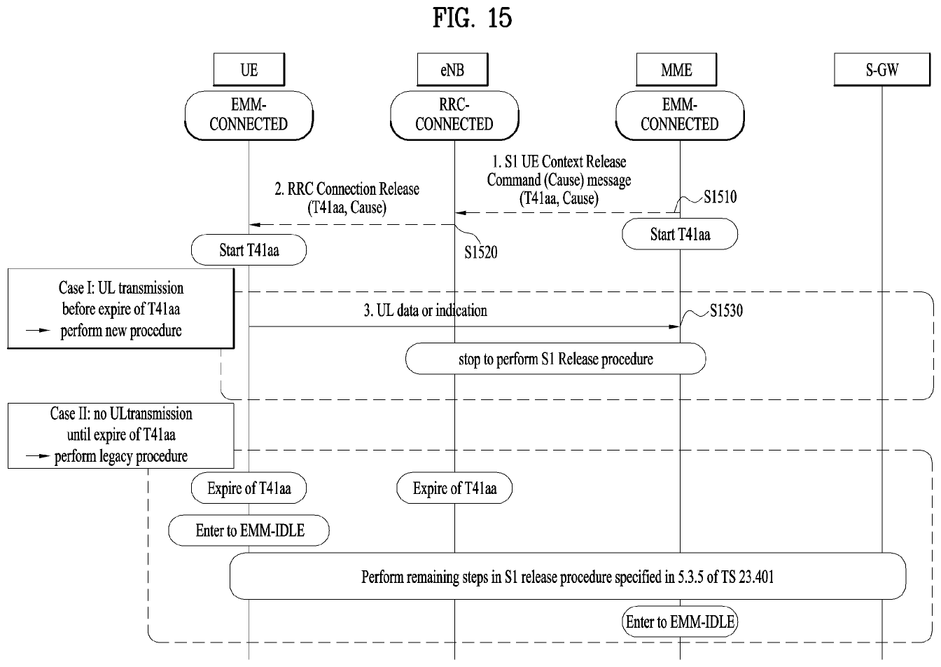

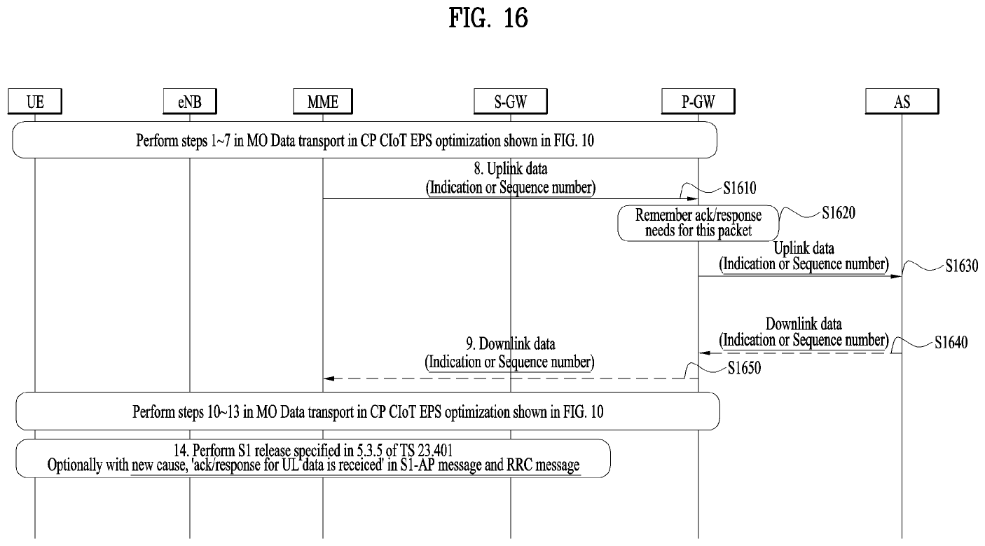

FIG. 15 is a diagram illustrating another exemplary S1 connection release procedure according to the proposal of the present invention. In particular, FIG. 15 illustrates the MME initiated S1 release procedure according to proposal 1-B. Hereinafter, proposal 1-B will be described with reference to FIG. 15. Referring to FIG. 15, the step (S1510) where the MME transmits an S1 UE Context Release Command (Cause) message to the eNB may correspond to step 4 mentioned in the foregoing description, the step (S1520) where the eNB transmits an RRC Connection Release message to the UE may correspond to step 5 mentioned in the foregoing description, and the step (S1530) where the UE transmits UL data or indication to the eNB may correspond to step 6 mentioned in the foregoing description.

When the UE that receives the RRC Connection Release message needs to perform UL transmission before the expiration of timer T41aa (case I of FIG. 15), the S1 release procedure according to the present invention can be performed. For example, when UL transmission is scheduled before timer T41aa expires, the UE may perform the UL transmission or transmit an indication to the eNB. On the other hand, when the UE that receives the RRC Connection Release message does not need to perform UL transmission before the expiration of timer T41aa (case II of FIG. 15), the UE enters the EMM-Idle state after the expiration of timer T41aa, and the conventional S1 release procedure (defined in section 5.3.5 of 3GPP TS 23.401) may be performed.

In steps S1510 and S1520 of FIG. 15, a cause may be included in the RRC Connection Release message. As the cause contained in the RRC Connection Release message, “arrival of expected DL packet” or an existing cause may be used. The existing cause will be described later. In addition, “no arrival of expected DL packet” may be defined as a new cause. When the RRC Connection Release message including the existing cause is received, the UE may be configured to interpret the existing cause as “no arrival of expected DL packet”.

Proposal 1-C) ENB-Triggered S1 Release

As mentioned in problem 4, the eNB-triggered S1 release may be divided into the two cases: the first case in which the MME triggers the S1 release so that the eNB initiates the S1 release; and the second case in which the eNB triggers and initiates the S1 release by itself. When the MME triggers the S1 release and then the eNB initiates the S1 release, it may be performed by a combination of proposals 1-A and 1-B. On the other hand, when the eNB initiates the S1 release by itself, it there occurs a problem that the eNB operates according the conventional S1 release procedure because the eNB cannot recognize that a DL packet is expected. To allow the eNB to recognize the situation where the DL packet is expected, the following methods can be used:

A method in which a UE's NAS layer informs an UE's AS layer that ‘a DL packet is expected’ and the UE's AS layer includes this information in an RRC message (e.g., RA msg5) to transmit it to an eNB; and/or

A method in which an MME informs an eNB that ‘a DL packet is expected’ (through an S1-AP message).

Proposal 2) Proposal for Solving Problem 1

Since the MME cannot read messages at an application layer, the MME may not know whether its received DL data is ACK/response to UL data. Specifically, the present invention proposes a method performed by an MME to recognize ACK/response.

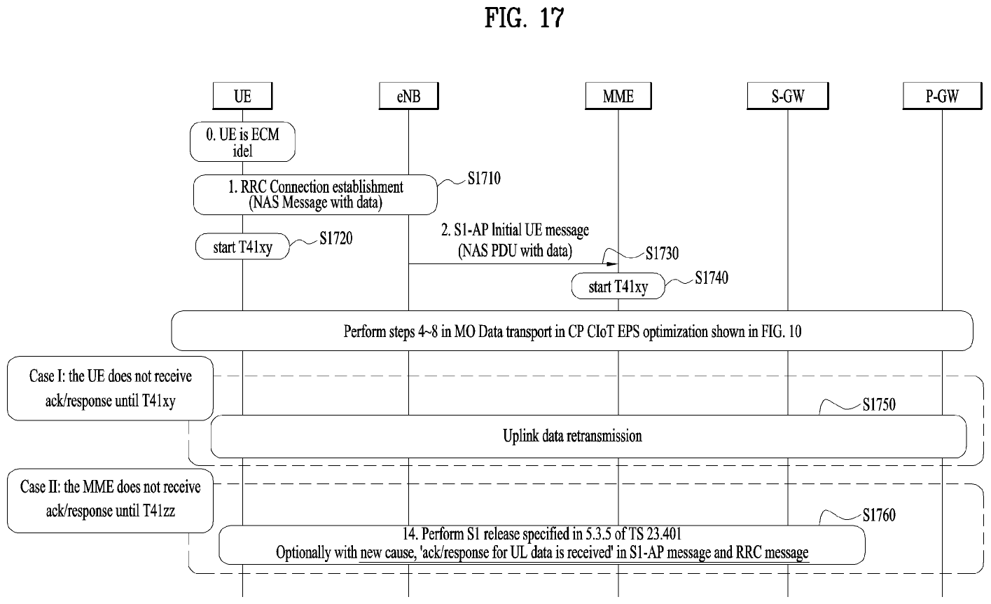

FIG. 16 is a diagram illustrating an exemplary S1 connection release procedure according to another proposal of the present invention. In particular, FIG. 16 shows the S1 release procedure according to proposal 2.

When the UE indicates the necessity of ACK/response through the release assistance information in the NAS message in step 1 of FIG. 10 (step 15 of FIG. 11 or step 1 of FIG. 13), steps subsequent to step 3 of FIG. 10 can be performed as follows.

> Step 3. The MME recognizes that the UE requires the ACK/response to the UL data, which was transmitted by the UE.

> Step 8-1. The MME includes the following contents in a GTP message (i.e., GTP-U message), where the UL data is included, and then transmit it to the P-GW [S1610]. Step 8-1 may be additionally performed when step 8 described in FIG. 10 is performed.

a. An indication or IE indicating that ‘the ACK/response to the UL data transmitted by the UE is needed’ is included.

b. Information for carrying the ACK/response to the corresponding UL data is included. This information may be a sequence number of the corresponding UL data, and it may be randomly allocated by the MME.

The MME may include both contents a and b or only content b in the GTP message containing the UL data.

> Step 8-2. When the GTP message (i.e., GTP-U message) transmitted from the MME in step 8 described in FIG. 10 contains content b (content a can also be included), the P-GW recognizes the necessity of the ACK/response to the UL data contained in the GTP message.

The P-GW memorizes the fact that the ACK/response to the corresponding UL data is needed and the sequence number [S1620].

The P-GW transfers the corresponding UL data to an application server (AS) [S1630]. In this case, the P-GW may also send the sequence number of the UL data to the application server.

> Step 9. When the P-GW receives the ACK/response to the UL data [S1640], for example, when the P-GW receives DL data corresponding to the sequence number of the UL data from the application server, the P-GW includes the sequence number and DL data in a GTP message (i.e., GTP-U message) and then transmits the GTP message to the MME [S1650].

> Step 14. When in step 9, the MME recognizes, through the sequence number included in the GTP message (i.e., GTP-U message), that the DL data contained in the GTP message is the ACK/response to the UL data transmitted in step 1, the MME may send a request for releasing the RRC connection to the eNB.

In this case, a cause value is written as ‘ACK/response for UL data is received’.

> Step 14. Upon receiving the request for releasing the RRC connection from the MME in step 11, the eNB transmits an RRC Connection Release message and the cause of ‘ACK/response for UL data is received’ to the UE.

Among the steps, step 8-2 may be performed as follows. In this case, steps 9 to 12-1 may be performed as described above.

> Step 8-2. When the GTP message (i.e., GTP-U message) transmitted from the MME in step 8-1 contains content b (content a can also be included in the message), the P-GW recognizes the necessity of the ACK/response to the UL data contained in the GTP message.

When forwarding the UE's UL data to a destination IP (e.g., AS), the P-GW transmits content b (content a can also be included) together with the data.

After receiving the data, the destination (e.g., AS) recognizes, through content b or content a, that the ACK/response to the UL data is required. When transmitting the ACK/response to the UL data, the destination transmits the sequence number of the UL data (i.e., the value in content b) to the P-GW.

To allow the P-GW to check the ACK/response to the UL data, an application layer may be added to the P-GW. Once the application layer is added, the P-GW can check the ACK/response at the application layer and then transmit it to the MME.

Proposal 3) Proposal for Solving Problem 3

Step 1 of proposal 3 may be performed during step 1 described in FIG. 10. Alternatively, step 8 of proposal 3 may be performed between step 7 of proposal 2 and step 9 of proposal 2 independently or instead of step 8-1 and/or step 8-2 of proposal 2. Further, step 9 of proposal 3 may be performed instead of or together with steps 9 to 12 of proposal 2.

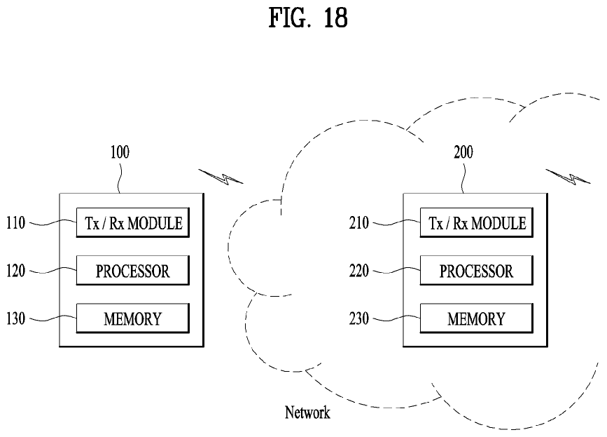

FIG. 17 is a diagram illustrating an exemplary S1 connection release procedure according to a further proposal of the present invention. In particular, FIG. 17 shows a case in which the S1 connection release procedure according to proposal 3 is applied to the procedure shown in FIG. 10.

> Step 1. The UE may establish an RRC connection and transmit UL data in a NAS message [S1710]. When the UE indicates the necessity of ACK or response through release assistance information in a NAS message, the UE transmits corresponding UL data and, at the same time, starts timer T41xy [S1720].

The value of timer T41xy is configured with respect to a round trip time (RTT) required for the UE to receive the ACK/response to the UL data after transmitting the corresponding UL data.

The value of timer T41xy may be pre-configured. Alternatively, it may be transferred from an application to a lower layer (e.g., NAS layer or AS layer).

If the UE fails to receive the ACK/response before expiration of timer T41xy (case I of FIG. 17), the UE retransmits the UL data [S1750]. Thereafter, the UE sets timer T41xy to the default value and then starts it again.

> Step 8. When the MME receives the indication indicating that the UE requires the ACK or response through the release assistance information in the NAS message [S1730], the MME forwards the UL data to the P-GW and, at the same time, starts timer T41yy.

When the MME does not receive the ACK/response until expiration of timer T41yy, the MME starts timer T41yz.

When the MME does not receive a new NAS message from the UE until expiration of timer T41yz, the MME performs the S1 release procedure. In this case, the MME operates as follows:

>> The MME requests the eNB to release an RRC connection through an S1-AP message; and/or

>> The MME transmits a Release Access Bearers Request message to the S-GW in order to release an S1-U bearer.

In this case, two timers, i.e., timers T41yy and T41yz may be used, or a single timer (e.g., timer T41zz) may replace the above-described two timers. When a single timer is used instead of the aforementioned two timers, the MME starts timer T41zz together with transmitting UL data [S1740]. When the MME does not receive the ACK/response from the P-GW or a new NAS message from the UE until expiration of timer T41zz (case II of FIG. 17), the MME performs the S1 release procedure [S1760]. The S1 release procedure using timer T41zz can be performed in the same manner as described above.

The value of timer T41yy or T41zz may be pre-configured at the MME, or it may be configured with respect to the value of timer T41xy. The value of timer T41yy or T41zz is set to be equal to or greater than that of timer T41xy. The value of timer T41yz may also be pre-configured.

The value of timer T41yy, timer T41yz, or timer T41zz may be pre-configured at the UE, or it may be transferred from the MME through a NAS message (e.g., attach accept, TAU accept, etc.).

> Step 9. When receiving the ACK/response to the UL data transmitted in step 8, the MME stops timer T41yy, T41yz, or T41zz and then perform the S1 release procedure as in the prior art. That is, the MME may send a request for releasing the RRC connection to the eNB. In this case, the MME may transmit the cause of ‘ACK/response is received’ to the eNB.

Referring to 3GPP TS 36.331, when an eNB transmits an RRC Connection Release message to a UE, the eNB may use the following cause: “loadBalancingTAURequired”, “cs-FallbackHighPriority”, “rrc-Suspend” and “other”. Referring to 3GPP TS 36.413, when an eNB transmits an RRC Connection Release message to a UE, the eNB may use the following cause: “Release due to E-UTRAN generated reason”, “CS Fallback triggered”, “User Inactivity”, “UE Not Available for PS Service?”, “Inter-RAT Redirection?”, and “Redirection towards 1×RTT”. In addition, when an MME transmits a UE Release Command message to a UE, the MME may use the cause of ‘Normal Release’.

If above-described proposal 1, proposal 2, and/or proposal 3 are applied to all S1 release procedures, it may cause unnecessary delay or signaling. Thus, the present invention can be limitedly applied only when, after checking the cause of S1 release, the cause matches the cause(s) described in the above-described proposal(s). For example, if the cause is User Inactivity, an eNB may include, as the release cause, User Inactivity in a release message. In this case, a UE may operate according to proposal 1, proposal 2, and/or proposal 3 of the present invention.

In a release assistance indication scenario, if a release procedure is performed due to arrival of an expected DL packet, a UE may operate according to the proposal(s) of the present invention. However, the release cause on the basis of arrival of an expected DL packet has not been defined. Therefore, the new cause of ‘arrival of expected DL packet’ may be included in a release message transmitted from an MME to an eNB (e.g., UE Release Command message) and a release message transmitted from an eNB to a UE (e.g., RRC Connection Release message) and then transmitted. Upon receiving the release cause, the UE can operate according to the proposal(s) of the present invention.

Additionally, when the release cause of “rrc-Suspend” or “other” is included in a release message transmitted from an eNB to a UE (e.g., RRC Connection Release message), the can operate according to the proposal(s) of the present invention.

The conventional S1 release procedure is performed immediately after or before a network (e.g., eNB, MME, etc.) transmits a release message to a UE. On the other hand, according to the proposal(s) of the present invention, a network transmits a release message to a UE and then stands by for a predetermined time. If the UE does not respond (or transmit data) during the predetermined time, release is performed. In particular, the present invention can be applied to not only CIoT communication but also general communication. Further, the invention can also be applied to the above-described specific causes/situations.

FIG. 18 is a diagram illustrating configurations of node devices according to a proposed embodiment.

A user equipment (UE) 100 may include a transceiver 110, a processor 120, and a memory 130. The transceiver 110 can be referred to as a radio frequency (RF) unit. The transceiver 110 may be configured to transmit and receive various signals, data, and information to/from an external device. Alternatively, the transceiver 110 may be implemented with a combination of a transmitter and a receiver. The UE 100 may be connected to the external device by wire and/or wirelessly. The processor 120 may be configured to control overall operations of the UE 100 and process information to be transmitted and received between the UE 100 and the external device. Moreover, the processor 120 may be configured to perform the UE operation proposed in the present invention. In addition, the processor 120 may be configured to control the transceiver 110 to transmit data or messages according to the proposals of the present invention. The memory 130, which may be replaced with an element such as a buffer (not shown in the drawing), may store the processed information for a predetermined time.

Referring to FIG. 18, a network node 200 according to the present invention may include a transceiver 210, a processor 220, and a memory 230. The transceiver 210 can be referred to as a radio frequency (RF) unit. The transceiver 210 may be configured to transmit and receive various signals, data, and information to/from an external device. The network node 200 may be connected to the external device by wire and/or wirelessly. The processor 220 may be configured to control overall operations of the network node 200 and process information to be transmitted and received between the network node device 200 and the external device. Moreover, the processor 220 may be configured to perform the network node operation proposed in the present invention. In addition, the processor 220 may be configured to control the transceiver 210 to transmit data or messages to a UE or another network node according to the proposals of the present invention. The memory 230, which may be replaced with an element such as a buffer (not shown in the drawing), may store the processed information for a predetermined time.

The specific configurations of the UE 100 and the network node 200 may be implemented such that the aforementioned various embodiments of the present invention can be independently applied or two or more embodiments can be simultaneously applied. For clarity, redundant description will be omitted.

The embodiments of the present invention may be implemented using various means. For instance, the embodiments of the present invention may be implemented using hardware, firmware, software and/or any combinations thereof.

In case of the implementation by hardware, a method according to each embodiment of the present invention may be implemented by at least one selected from the group consisting of ASICs (application specific integrated circuits), DSPs (digital signal processors), DSPDs (digital signal processing devices), PLDs (programmable logic devices), FPGAs (field programmable gate arrays), processor, controller, microcontroller, microprocessor and the like.

In case of the implementation by firmware or software, a method according to each embodiment of the present invention can be implemented by modules, procedures, and/or functions for performing the above-explained functions or operations. Software code may be stored in a memory unit and be then executed by a processor. The memory unit may be provided within or outside the processor to exchange data with the processor through the various means known to the public.

As mentioned in the foregoing description, the detailed descriptions for the preferred embodiments of the present invention are provided to be implemented by those skilled in the art. While the present invention has been described and illustrated herein with reference to the preferred embodiments thereof, it will be apparent to those skilled in the art that various modifications and variations can be made therein without departing from the spirit and scope of the invention. Therefore, the present invention is non-limited by the embodiments disclosed herein but intends to give a broadest scope matching the principles and new features disclosed herein.

### INDUSTRIAL APPLICABILITY

The aforementioned communication method can be applied to various wireless communication systems including IEEE 802.16x and 802.11x systems as well as the 3GPP system. Further, the proposed method is applicable to a millimeter wave (mm Wave) communication system using ultra-high frequency bands.

1. A method for performing an S1 release procedure by a mobile management entity (MME) in a wireless communication system, the method comprising:
receiving, from a user equipment (UE), a non-access stratum (NAS) UL message including uplink (UL) data and release assistance information indicating that the UE expects a downlink (DL) response to the UL data;
forwarding the UL data to a serving gateway (S-GW);
when the DL response to the UL data is received from the S-GW, starting a first timer and transmitting, to an evolved node B (eNB), an S1 UE Context Release Command message including the DL response; and
performing the S1 release procedure after expiration of the first timer.

2. The method of claim 1, wherein the S1 release procedure comprises transmitting a Release Access Bearers Request message to the S-GW after the expiration of the first timer.

3. The method of claim 1, wherein the S1 UE Context Release Command message includes a first timer value of the first timer.

4. The method of claim 1, wherein the S1 UE Context Release Command message includes a cause value, and wherein the cause value indicates either that the DL response to the UL data is received or that the DL response to the UL data is not received.

5. The method of claim 1, wherein the UL data is transmitted to a packet data network (PDN) gateway (P-GW) through the S-GW in a first general packet radio service (GPRS) tunneling protocol (GTP) message,
wherein the DL response is received from the P-GW through the S-GW in a second GTP message,
wherein the first GTP message includes an indication indicating that the DL response to the UL data is required or a sequence number of the UL data, and
wherein the second GTP message includes the sequence number.

6. The method of claim 1, wherein transmitting the UL data to the S-GW comprises starting a second timer different from the first timer, and
wherein the method comprises, when the DL response is received from the S-GW before expiration of the second timer, stopping the second timer, starting the first timer, and transmitting the S1 UE Context Release Command message to the eNB.

7. A method for performing an S1 release procedure by a base station (evolved node B (eNB)) in a wireless communication system, the method comprising:
receiving a S1 UE Context Release Command message from a mobile management entity (MME);
transmitting a radio resource control (RRC) Connection Release message to a user equipment (UE); and
performing the S1 release procedure including RRC Connection Release,
wherein when a message including an indication indicating that the UE expects a downlink (DL) response to uplink (UL) data, which was transmitted by the UE in a non-access stratum (NAS) UL message, is received, the S1 release procedure is performed after expiration of the first timer, which started with the transmission of the RRC Connection Release message.

8. The method of claim 7, wherein the S1 UE Context Release Command message or the RRC Connection Release message includes a timer value of the first timer.

9. The method of claim 7, wherein the S1 UE Context Release Command message includes a cause value indicating either that the DL response to the UL data is received or that the DL response to the UL data is not received, and
wherein the RRC Connection Release message includes a cause value identical to the cause value in the S1 UE Context Release Command message.

10. The method of claim 7, wherein the message including the indication indicating that the DL response is expected is received from the MME rather than the UE.

11. A mobile management entity for performing an S1 release procedure in a wireless communication system, the MME comprising:
a radio frequency (RF) unit; and
a processor configured to control the RF unit,
wherein the processor is configured to:
control the RF unit to receive, from a user equipment (UE), a non-access stratum (NAS) UL message including uplink (UL) data and release assistance information indicating that the UE expects a downlink (DL) response to the UL data;
control the RF unit to forward the UL data to a serving gateway (S-GW);
when the DL response to the UL data is received from the S-GW, start a first timer and control the RF unit to transmit, to an evolved node B (eNB), an S1 UE Context Release Command message including the DL response; and
perform the S1 release procedure after expiration of the first timer.

12. The MME of claim 11, wherein the processor is configured to perform the S1 release procedure by controlling the RF unit to transmit a Release Access Bearers Request message to the S-GW after the expiration of the first timer.

13. The MME of claim 11, wherein the S1 UE Context Release Command message includes a first timer value of the first timer.

14. The MME of claim 11, wherein the S1 UE Context Release Command message includes a cause value, and
wherein the cause value indicates either that the DL response to the UL data is received or that the DL response to the UL data is not received.

15. A base station (evolved Node B (eNB)) for performing an S1 release procedure in a wireless communication system, the eNB comprising:
a radio frequency (RF) unit; and
a processor configured to control the RF unit,
wherein the processor is configured to:
control the RF unit to receive a S1 UE Context Release Command message from a mobile management entity (MME);
control the RF unit to transmit a radio resource control (RRC) Connection Release message to a user equipment (UE); and
perform the S1 release procedure including RRC Connection Release,
wherein when a message including an indication indicating that the UE expects a downlink (DL) response to uplink (UL) data, which was transmitted by the UE in a non-access stratum (NAS) UL message, is received, the processor is configured to perform the S1 release procedure after expiration of the first timer, which started with the transmission of the RRC Connection Release message.

16. The eNB of claim 15, wherein the S1 UE Context Release Command message includes a cause value indicating either that the DL response to the UL data is received or that the DL response to the UL data is not received, and
wherein the RRC Connection Release message includes a cause value identical to the cause value in the S1 UE Context Release Command message.

17. The eNB of claim 15, wherein the message including the indication indicating that the DL response is expected is received from the MME rather than the UE.
